(19) United States
(12) Patent Application Publication
(10) Pub. No.: US 2026/0161280 A1
(43) Pub. Date: Jun. 11, 2026

(54) ELECTRONIC DEVICE, METHOD, AND NON-TRANSITORY COMPUTER READABLE STORAGE MEDIUM TO OUTPUT MEDIA CONTENT BASED ON ACCESSIBILITY FUNCTION BEING EXECUTED BY EXTERNAL ELECTRONIC DEVICE

(71) Applicant: Samsung Electronics Co., Ltd., Suwon-si (KR)

(72) Inventor: Jaesung PARK, Suwon-si (KR)

(21) Appl. No.: 19/323,276

(22) Filed: Sep. 9, 2025

Related U.S. Application Data
(63) Continuation of application No. PCT/KR2025/013426, filed on Sep. 2, 2025.

(30) Foreign Application Priority Data
Dec. 11, 2024 (KR) 10-2024-0184195

(51) Int. Cl. G06F 3/04847; G06F 3/0487

(52) U.S. Cl. CPC G06F 3/04847; G06F 3/0487

(57) ABSTRACT

An electronic device may identify an external electronic device using at least communication circuitry. The electronic device may obtain, based on identifying the external electronic device, from the external electronic device, information indicating at least one first accessibility function being executed by the external electronic device. The electronic device may identify, using the obtained information, at least one second accessibility function among accessibility functions executable by the electronic device, which corresponds to the at least one first accessibility function indicated by the information. The electronic device may execute the at least one second accessibility function to change media content to be displayed via a display.

### CROSS-REFERENCE TO RELATED APPLICATIONS

This application is a continuation application of International Application No. PCT/KR2025/013426, filed on September 2, in the Korean Intellectual Property Receiving Office, and claiming priority to Korean Patent Application No. 10-2024-0184195 filed Dec. 11, 2024, the disclosures of which are all hereby incorporated by reference herein in their entireties.

### TECHNICAL FIELD

Certain example embodiments may relate to an electronic device, a method, and/or a non-transitory computer readable storage medium configured to output media content based on an accessibility function being executed by an external electronic device.

### BACKGROUND

An accessibility function is provided by an electronic device to compensate for a disability of a user using the electronic device. For example, for a user with low vision, the electronic device may change the font size of text displayed via a display to a size exceeding a reference size. For example, for a user with low vision, the electronic device may generate or output an audio signal corresponding to text displayed via the display, based on text to speech (TTS). For example, to compensate for hearing loss of a user, the electronic device may reproduce an audio signal at an intensity exceeding a reference intensity.

The above-described information may be provided as related art for the purpose of helping the understanding of the present disclosure. No claim or determination is raised as to whether any of the above-described content may be applied as prior art associated with the present disclosure.

### SUMMARY

According to an example embodiment, an electronic device may comprise a display, communication circuitry, memory comprising one or more storage media storing instructions, and at least one processor comprising processing circuitry. The instructions, when executed by the at least one processor individually and/or collectively, may cause the electronic device to identify an external electronic device using the communication circuitry. The instructions, when executed by the at least one processor individually and/or collectively, may cause the electronic device to obtain, based on identifying the external electronic device, from the external electronic device, information indicating at least one first accessibility function being executed by the external electronic device. The instructions, when executed by the at least one processor individually and/or collectively, may cause the electronic device to identify, using the obtained information, at least one second accessibility function among accessibility functions executable by the electronic device, which corresponds to the at least one first accessibility function indicated by the information. The instructions, when executed by the at least one processor individually and/or collectively, may cause the electronic device to execute the at least one second accessibility function to change media content to be displayed through the display.

In an example embodiment, a method of an electronic device including a display and communication circuitry may be provided. The method may comprise identifying an external electronic device using at least the communication circuitry. The method may comprise obtaining, based on identifying the external electronic device, from the external electronic device, information indicating at least one first accessibility function being executed by the external electronic device. The method may comprise identifying, using the obtained information, at least one second accessibility function among accessibility functions executable by the electronic device, which correspond to the at least one first accessibility function indicated by the information. The method may comprise executing the at least one second accessibility function to change media content to be displayed through the display.

In an example embodiment, a non-transitory computer readable storage medium storing instructions may be provided. The instructions, when executed by an electronic device comprising output circuitry including at least one of a display or a speaker, and communication circuitry, may cause the electronic device to identify an external electronic device using the communication circuitry. The instructions, when executed by the electronic device, may cause the electronic device to obtain, based on identifying the external electronic device, from the external electronic device, first text indicating at least one first accessibility function being executed by the external electronic device. The instructions, when executed by the electronic device, may cause the electronic device to identify, using second texts respectively corresponding to second accessibility functions executable by the electronic device, at least one second accessibility function corresponding to the at least one first accessibility function among the second accessibility functions. The instructions, when executed by the electronic device, may cause the electronic device to apply, to media content being output through the output circuitry, the identified at least one second accessibility function.

According to an example embodiment, an electronic device may comprise output circuitry including at least one of a display or a speaker, communication circuitry, memory comprising one or more storage media storing instructions, and at least one processor comprising processing circuitry. The instructions, when executed by the at least one processor individually or collectively, may cause the electronic device to identify an external electronic device using the communication circuitry. The instructions, when executed by the at least one processor individually or collectively, may cause the electronic device to obtain, based on identifying the external electronic device, from the external electronic device, first text indicating at least one first accessibility function being executed by the external electronic device. The instructions, when executed by the at least one processor individually or collectively, may cause the electronic device to identify, using second texts respectively corresponding to second accessibility functions executable by the electronic device, at least one second accessibility function corresponding to the at least one first accessibility function among the second accessibility functions. The instructions, when executed by the at least one processor individually or collectively, may cause the electronic device to apply, to media content being output through the output circuitry the identified at least one second accessibility function.

### DESCRIPTION OF THE DRAWINGS

FIG. 1 illustrates an example embodiment of an electronic device that outputs media content based on an accessibility function being executed on an external electronic device.

FIG. 2 schematically illustrates hardware components of an electronic device according to an example embodiment.

FIG. 3 illustrates an exemplary flowchart for describing an operation of an electronic device according to an example embodiment.

FIG. 4 illustrates an exemplary flowchart for describing an operation of an electronic device that has identified a plurality of external electronic devices.

FIG. 5 illustrates an exemplary operation of an electronic device that determines an accessibility function to be executed in the electronic device based on a comparison of text.

FIG. 6 illustrates an exemplary operation of an electronic device that obtains an attribute associated with an accessibility function using a server.

FIG. 7 exemplarily illustrates example accessibility functions executable in an electronic device based on communication with an external electronic device.

FIG. 8 schematically illustrates an example operation of an electronic device that identifies motion of a user based on an attribute of an accessibility function being executed in an external electronic device.

FIG. 9 illustrates an exemplary state of an electronic device connected to an external electronic device, which is a head-wearable electronic device.

FIG. 10 illustrates an exemplary operation of an electronic device that determines whether to terminate an accessibility function executed based on communication with an external electronic device.

### DETAILED DESCRIPTION

Hereinafter, various example embodiments of the present document will be described with reference to the accompanying drawings.

The various embodiments of the present document and terms used herein are not intended to limit the technology described in the present document to specific embodiments, and should be understood to include various modifications, equivalents, or substitutes of the corresponding embodiment. In relation to the description of the drawings, a reference numeral may be used for a similar component. A singular expression may include a plural expression unless it is clearly meant differently in the context. In the present document, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, are only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the present document may include a unit configured with hardware may be used interchangeably with terms such as component and/or circuit, and the like. The module may be an integrally configured component or a minimum unit or part thereof that performs one or more functions. For example, a module may be configured with an application-specific integrated circuit (ASIC).

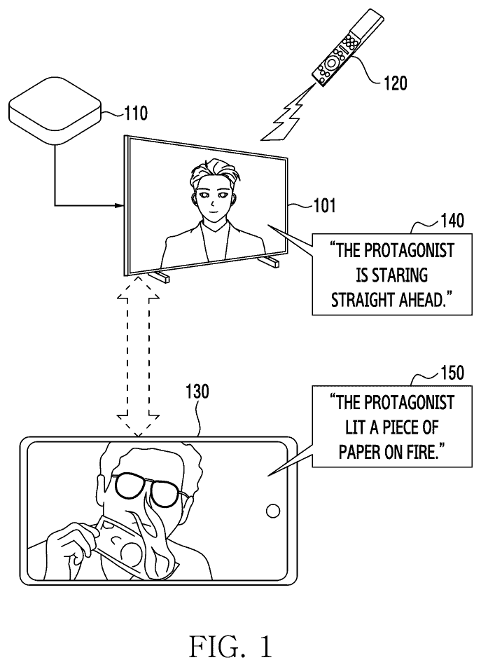

FIG. 1 illustrates an embodiment of an electronic device 101 that outputs media content based on an accessibility function being executed on an external electronic device (e.g., a user terminal 130). The electronic device 101 may be described as an electronic device capable of providing and/or outputting (or displaying) video, audio, or any combinations thereof. For example, the electronic device 101 may include a television (TV), a set-top box (STB) 110, a monitor, a computer, a smartphone, a tablet, a portable media player, a wearable device, a video wall, a digital photo frame, and the like. The electronic device 101 may be referred to as a display device. A video, audio, or any combinations thereof that may be displayed through the electronic device 101 may be referred to as media content (or multimedia content).

Hereinafter, for convenience of explanation, it is assumed that the electronic device 101 is implemented as a TV, but an embodiment is not limited thereto. For example, the STB 110 may be configured to perform an operation of the present disclosure. When connected to a display device such as a TV, the STB 110 may transmit information indicating video, audio, or a combination thereof (e.g., media content) to the display device. The display device connected to the STB 110 may display the video indicated by the information and/or output the audio indicated by the information, based on receiving the information.

Referring to FIG. 1, the electronic device 101 may receive a user input for executing a function of the electronic device 101 through an input means of the electronic device 101. The input means may include at least one of a switch (or button) that is at least partially visible through a housing of the electronic device 101, a touch sensor (e.g., a pressure-sensitive touch sensor and/or a capacitive touch sensor) for detecting a touch input on the housing (and/or a display panel) of the electronic device 101, a microphone, or a motion sensor (e.g., a light detection and ranging (LiDAR) sensor and/or a time-of-flight (ToF) sensor) for detecting a motion and/or gesture of a user spaced apart from the electronic device 101.

In an embodiment, a user input may be received (indirectly) not only through the input means of the electronic device 101 but also through another electronic device (e.g., the STB 110 and/or a remote controller 120) connected to the electronic device 101. For example, the remote controller 120 may transmit information to the electronic device 101 indicating at least one of a button press on the remote controller 120, a touch gesture performed on a side of the remote controller 120, a physical movement of the remote controller 120, and/or an audio signal received through a microphone of the remote controller 120. The electronic device 101 may detect or identify the user input using the information received from the remote controller 120. In the present disclosure, a “user input” may include an input identified not only through an input means of the electronic device 101 but also through an external electronic device connected to the electronic device 101, such as the remote controller 120.

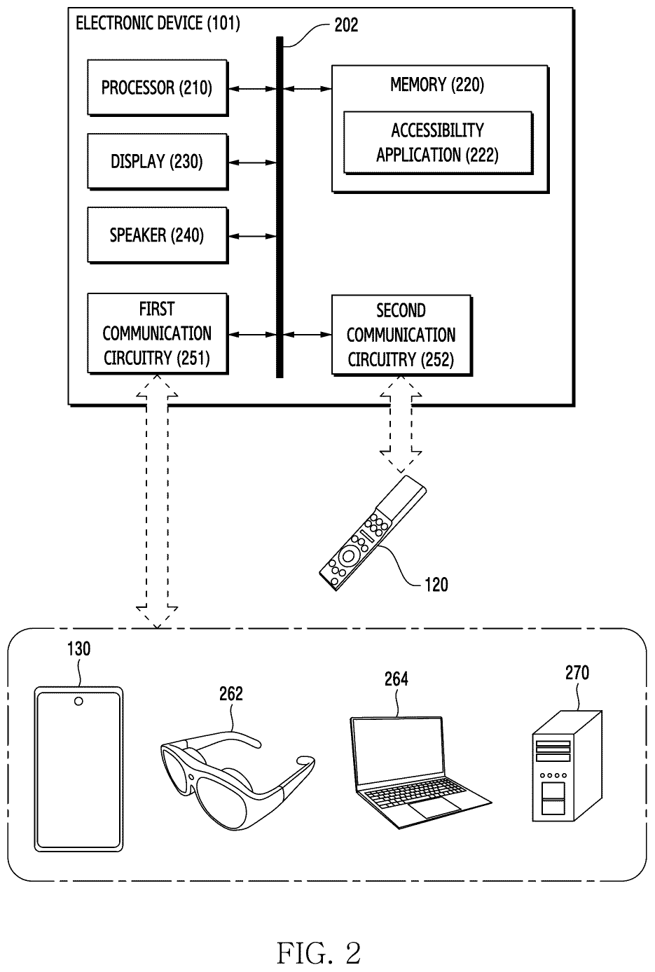

Referring to FIG. 1, the electronic device 101 may be connected to the remote controller 120, the STB 110, and/or another electronic device (e.g., the user terminal 130 and/or a server 270 of FIG. 2). For example, a connection between the electronic device 101 and the STB 110 may include a wired connection based on a high-definition multimedia interface (HDMI), RGB, digital visual interface (DVI), DisplayPort (DP), component video, Thunderbolt, and/or Auxiliary (Aux) cable. An embodiment is not limited thereto, and the connection between the electronic device 101 and the STB 110 may include a wireless connection such as wireless fidelity (WiFi), WiFi-direct, and/or Wireless Display (WiDi). For example, a connection between the electronic device 101 and the remote controller 120 may include a wireless connection based on infrared (IR). An embodiment is not limited thereto, and the remote controller 120 may be connected to the electronic device 101 based on Bluetooth, Bluetooth low energy (BLE), near-field communication (NFC), ultra-wideband (UWB), WiFi, WiFi-direct, and/or another wireless short-range communication protocol. Exemplary hardware included in the electronic device 101 for outputting media content and/or for communicating with an external electronic device (e.g., the remote controller 120, the STB 110, and/or the user terminal 130) is described with reference to FIG. 2.

Referring to FIG. 1, an exemplary state in which a communication link (e.g., a communication link based on wireless communication) is established between the electronic device 101 and the user terminal 130 is illustrated. The electronic device 101 may identify an external electronic device such as the user terminal 130 using communication circuitry. Although an exemplary state in which the electronic device 101 communicates with one user terminal 130 is illustrated, the electronic device 101 may communicate with a plurality of user terminals.

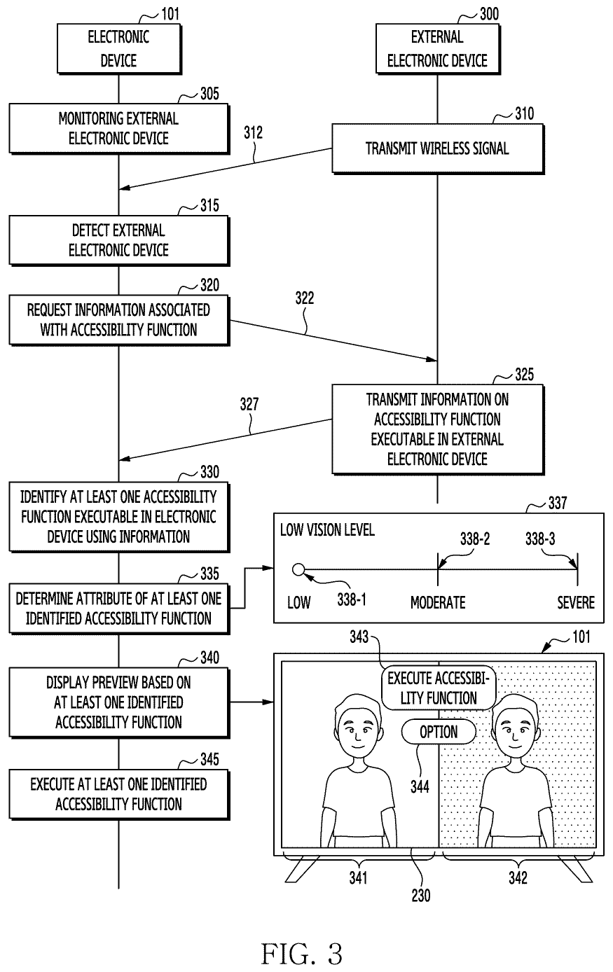

Exemplary operations of the electronic device 101 communicating with one or more external electronic devices including the user terminal 130 are described with reference to FIGS. 3 and/or 4.

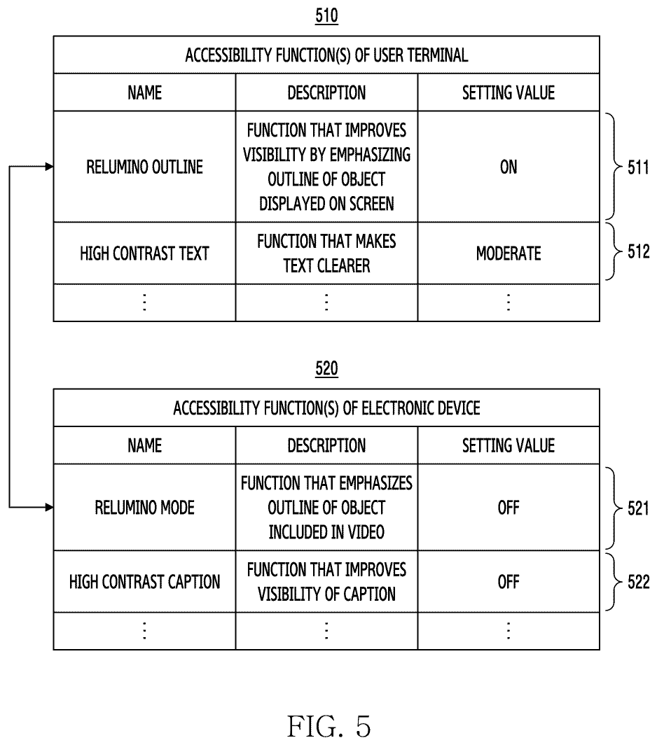

In the exemplary state of FIG. 1, the user terminal 130 may be configured to execute one or more accessibility functions. In the present disclosure, an accessibility function may include a program installed in the user terminal 130 to compensate for a disability of a user, and an operation performed in the user terminal 130 based on the execution of the program. For example, the accessibility function may include a function for changing color distribution of a video in media content being reproduced through a display using an attribute associated with color blindness (e.g., anomalous trichromacy such as protanomaly, deuteranomaly, and tritanomaly, dichromacy such as protanopia, deuteranopia, and tritanopia, and/or monochromacy such as complete color blindness and rod monochromacy). For example, the accessibility function may include a function for displaying one or more prompts for describing the media content. For example, the accessibility function may include a function for outputting an audio signal (e.g., an audio signal including a speech 150) through a speaker for describing a video in the media content being reproduced through the display. An embodiment is not limited to the above examples, and accessibility function(s) supported by the electronic device 101 and/or the user terminal 130 are described with reference to FIGS. 5, 7, 8, and/or 9.

Referring to FIG. 1, an exemplary state of the user terminal 130 is illustrated in which an accessibility function (e.g., an accessibility function referred to as screen narration) that outputs an audio signal (e.g., an audio signal indicating the speech 150) describing a video being reproduced through the display is activated. For example, the user terminal 130 may output a first audio signal associated with the video being reproduced through the display, along with a second audio signal for the speech 150 describing content of the video. The second audio signal may be reproduced from text indicating the content of the video, such as text-to-speech (TTS) performed in the user terminal 130.

In an embodiment, the electronic device 101 that has identified an external electronic device such as the user terminal 130 may obtain information from the external electronic device indicating at least one accessibility function (the accessibility function referred to as screen narration in the exemplary state of FIG. 1) being executed by the external electronic device. For example, the electronic device 101 may request information associated with the accessibility function(s) supported by the user terminal 130 from the user terminal 130. The request may be performed when the same user is logged into the electronic device 101 and the user terminal 130. Information indicating an accessibility function that the electronic device 101 obtains from the user terminal 130 may include not only the information but also setting value(s) (e.g., setting value(s) indicating volume and/or display brightness as well as indicating whether accessibility functions are being executed) personalized by the user of the user terminal 130.

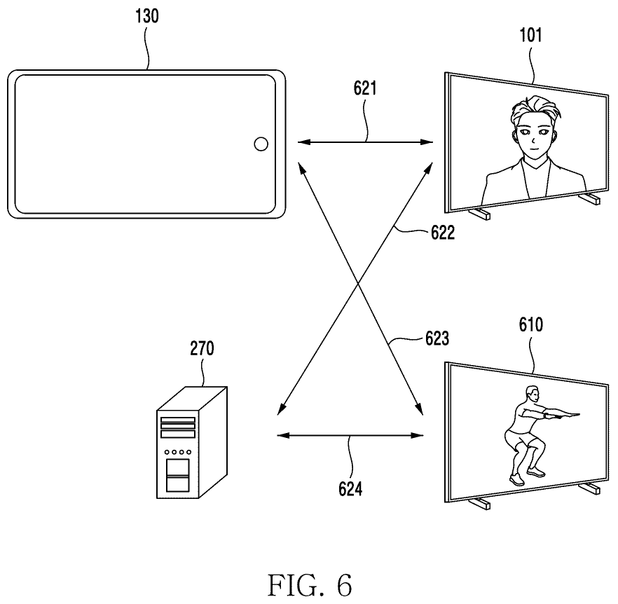

For example, when both the electronic device 101 and the user terminal 130 are associated with the same account information (e.g., account information registered in a server configured to communicate with both the electronic device 101 and the user terminal 130 by the user), the electronic device 101 may request the information from the user terminal 130. An exemplary state in which the server, the electronic device 101, and the user terminal 130 are interconnected is described with reference to FIG. 6.

In the exemplary state of FIG. 1, the user terminal 130 may transmit the information associated with the accessibility function(s) of the user terminal 130 to the electronic device 101, based on the request transmitted from the electronic device 101. The information may include a list of accessibility function(s) that may be supported by the user terminal 130. The information may include at least one attribute used for execution of an accessibility function by the user terminal 130. The information may include data (e.g., a name of the accessibility function and/or a description of the accessibility function) for identifying an accessibility function (e.g., the accessibility function referred to as screen narration in the exemplary state of FIG. 1) currently being executed in the user terminal 130.

Based on obtaining the information from the user terminal 130 that received the request, the electronic device 101 may identify or search, using the obtained information, at least one accessibility function among accessibility functions executable by the electronic device 101, which corresponds to at least one accessibility function indicated by the information. For example, the accessibility functions executable by the electronic device 101 and the accessibility functions executable by the user terminal 130 may have different names, even though they are substantially the same functions. The electronic device 101 may identify an accessibility function of the electronic device 101 corresponding to an accessibility function (e.g., the accessibility function referred to as screen narration) being executed on the user terminal 130 by comparing the names.

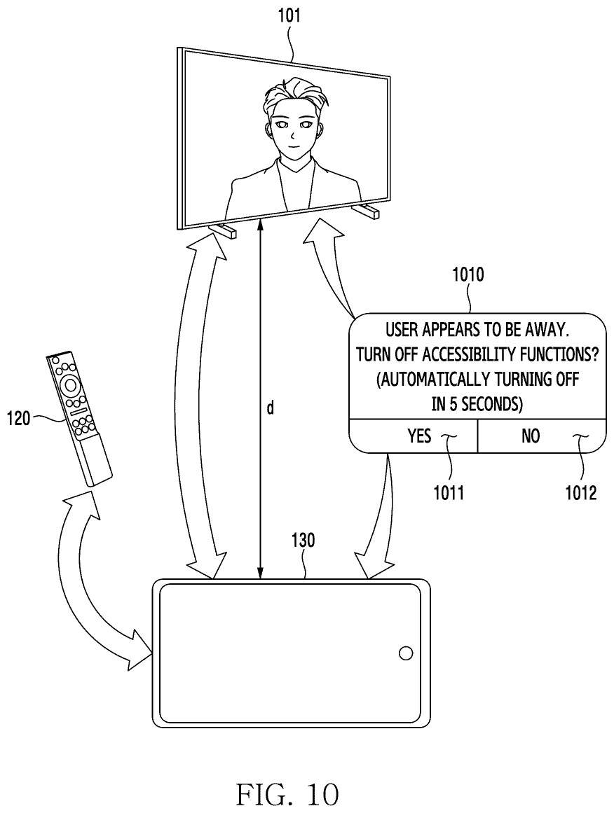

Referring to FIG. 1, based on identifying a first accessibility function (e.g., the accessibility function referred to as screen narration) being executed by the user terminal 130, which is indicated by the information obtained from the user terminal 130, the electronic device 101 may execute a second accessibility function corresponding to the first accessibility function among the accessibility functions executable by the electronic device 101. For example, the electronic device 101 may output an audio signal (e.g., an audio signal including a speech 140) for describing a video in media content being outputted through the electronic device 101 based on the execution of the second accessibility function. Since the electronic device 101 executes (automatically) the second accessibility function based on identifying the user terminal 130, an action required for the user to execute the second accessibility function may be minimized, reduced, or eliminated. In the exemplary state of FIG. 1, the audio signal including the speech 140 may be outputted more quickly based on movement of the user owning the user terminal 130 to the electronic device 101. Connectivity between the electronic device 101 and the user terminal 130 may be dependent on a distance between the electronic device 101 and the user terminal 130. An exemplary operation of the electronic device 101 ceasing the execution of the second accessibility function based on the distance is described with reference to FIG. 10.

As described above, according to an embodiment, the electronic device 101 (e.g., TV) may switch (automatically) a mode of the electronic device 101 to a mode that provides media content according to an accessibility function, based on the accessibility function being executed in the user terminal 130. In other words, the present disclosure may be associated with a method of automatically switching the mode of the electronic device 101 based on the accessibility function of the user terminal 130. Even if the user terminal 130 and the electronic device 101 support substantially the same accessibility function, the accessibility function may have different names in the user terminal 130 and the electronic device 101, respectively. According to an embodiment, the electronic device 101 may identify or determine an accessibility function of the electronic device 101 corresponding to the accessibility function being executed in the user terminal 130 based on a comparison of the names. The electronic device 101 may provide a consistent user experience associated with the accessibility function in both the user terminal 130 and the electronic device 101 based on execution of the identified accessibility function. The execution of the accessibility function by the electronic device 101 may be performed based on identifying an external electronic device (e.g., the user terminal 130) that is being moved toward the electronic device 101.

Hereinafter, an exemplary structure of hardware included in the electronic device 101 of FIG. 1 is described with reference to FIG. 2.

FIG. 2 schematically illustrates hardware components of an electronic device 101 according to an embodiment. The electronic device 101 of FIG. 2 may include the electronic device 101 and/or the STB 110 of FIG. 1.

Referring to FIG. 2, according to an embodiment, the electronic device 101 may include a processor 210 and/or memory 220. The electronic device 101 may (further) include a display 230 and/or a speaker 240. The electronic device 101 may (further) include first communication circuitry 251 and/or second communication circuitry 252. The processor 210 may be (electronically and/or operably) connected to the memory 220, the display 230, the speaker 240, the first communication circuitry 251, and/or the second communication circuitry 252 through an electronic component such as a communication bus 202. Hardware included in the electronic device 101 is not limited to an embodiment of FIG. 2. For example, the electronic device 101 may further include hardware not illustrated in FIG. 2. For example, the electronic device 101 may be implemented or produced based on a portion of the hardware illustrated in FIG. 2.

Referring to FIG. 2, the processor 210 of the electronic device 101 may include circuitry (e.g., processing circuitry) for processing data based on instructions. The circuitry for processing data may include, for example, an arithmetic and logic unit (ALU), a floating point unit (FPU), a field programmable gate array (FPGA), a central processing unit (CPU), a graphic processing unit (GPU), a neural processing unit (NPU), and/or an application processor (AP). For example, the number of processors 210 included in the electronic device 101 may be one or more. The processing circuitry of the processor 210 that loads (or fetches) an instruction and performs a calculation corresponding to the loaded instruction may be referred to or referenced as core circuitry (or core). For example, the processor 210 may have a structure of a multi-core processor including a plurality of core circuitry, such as a dual core, a quad core, a hexa core, or an octa core. A function and/or an operation described with reference to the present disclosure may be performed individually or collectively by one or more processing circuitry included in the processor 210.

Referring to FIG. 2, the memory 220 of the electronic device 101 may include circuitry for storing data and/or instructions that are inputted to or outputted from the processor 210. The memory 220 may include, for example, volatile memory such as random-access memory (RAM) and/or non-volatile memory such as read-only memory (ROM). The non-volatile memory may be referred to as storage. The volatile memory may include, for example, at least one of dynamic RAM (DRAM), static RAM (SRAM), Cache RAM, or pseudo SRAM (PSRAM). The non-volatile memory may include, for example, at least one of programmable ROM (PROM), erasable PROM (EPROM), electrically erasable PROM (EEPROM), flash memory, a hard disk, a compact disk, a solid state drive (SSD), or an embedded multi media card (eMMC). The memory 220 may include one or more storage media (e.g., the volatile memory and/or non-volatile memory described above) positioned in a distributed manner in the electronic device 101. The processor 210 may perform a function and/or an operation indicated by the instructions by executing the instructions of the memory 220. For example, when the electronic device 101 includes at least one processor, the at least one processor may be configured to execute the instructions collectively or individually.

Referring to FIG. 2, the display 230 of the electronic device 101 may be visible from a side (e.g., a front side) of the electronic device 101. The display 230 may be referred to as a display panel. The display 230 may include a liquid crystal display (LCD), a plasma display panel (PDP), or a plurality of LEDs. The display 230 may include an organic LED (OLED). In an embodiment, the display 230 may include electronic paper. When the display 230 has a flat shape, the display 230 may be referred to as a flat panel display (FPD). When the display 230 has a curved shape, the display 230 may be referred to as a curved display. When the display 230 has a deformable shape, the display 230 may be referred to as a bendable display, a flexible display, and/or a rollable display. The display 230 may include a beam projector (e.g., a digital light processing (DLP) projector and/or a liquid crystal display (LCD) projector).

Referring to FIG. 2, the speaker 240 of the electronic device 101 may be configured to output sound waves based on an electrical signal (e.g., an audio signal) provided from the processor 210. The number of speakers 240 included in the electronic device 101 may be one or more. For example, the electronic device 101 may include a plurality of speakers to reproduce multi-channel audio. While reproducing media content, the processor 210 may display a screen based on a video of the media content through the display 230. While outputting the video through the display 230, the processor 210 may transmit an audio signal of the media content to the speaker 240.

Referring to FIG. 2, the first communication circuitry 251 of the electronic device 101 may include hardware for supporting transmission and/or reception of information (or an electrical signal) between the electronic device 101 and an external electronic device (e.g., a user terminal 130, a head-mounted display (HMD) device 262, a laptop personal computer (PC) 264, and/or a server 270). The first communication circuitry 251 may include, for example, at least one of a modem, an antenna, or an optic/electronic (O/E) converter. The first communication circuitry 251 may support transmission and/or reception of an electrical signal based on various types of protocols such as Ethernet, local area network (LAN), wide area network (WAN), wireless fidelity (WiFi), near-field communication (NFC), Bluetooth, Bluetooth low energy (BLE), ZigBee, long term evolution (LTE), fifth generation (5G) new radio (NR), sixth generation (6G), and/or above-6G.

Referring to FIG. 2, the second communication circuitry 252 of the electronic device 101 may be configured to communicate with a remote controller 120. The second communication circuitry 252 may include a sensor (e.g., an IR sensor) for detecting an IR signal emitted from the remote controller 120. A sensor included in the second communication circuitry 252 is not limited to the IR sensor. For example, the second communication circuitry 252 may include circuitry based on WiFi, WiFi-direct, near-field communication (NFC), ultra-wideband (UWB), Bluetooth, and/or Bluetooth low energy (BLE) as a system for communicating with the remote controller 120.

A hardware component included in the electronic device 101 is not limited to the processor 210, the memory 220, the display 230, the speaker 240, the first communication circuitry 251, and the second communication circuitry 252 illustrated in FIG. 2. For example, the electronic device 101 may include input circuitry for receiving a user input associated with the electronic device 101. For example, the input circuitry may be connected to at least one button visible through at least a portion of a housing of the electronic device 101. When the at least one button is pressed, an electrical signal indicating the pressing of the at least one button may be transmitted to the processor 210 through the input circuitry. For example, the input circuitry may include a touch sensor for detecting contact (e.g., contact of a finger) on a surface of the housing of the electronic device 101. For example, the input circuitry may include a microphone. An electrical signal outputted from the microphone to the processor 210 may include digital code(s) indicating vibration of air adjacent to the microphone. The processor 210 may receive an electrical signal from the input circuitry by being electronically connected to the input circuitry. The processor 210 may detect or identify the user input using the received electrical signal.

Although a hardware structure of the electronic device 101 based on an embodiment in which the electronic device 101 is a TV is described, an embodiment is not limited thereto. For example, in an embodiment in which the electronic device 101 is the STB 110 of FIG. 1, the electronic device 101 may be implemented or produced without at least one of the display 230 or the speaker 240 illustrated in FIG. 2. For example, the electronic device 101 may include a wired interface (e.g., HDMI, DVI, and/or DP) for transmitting information and/or a signal indicating an image and/or a video to an external display connected to the electronic device 101. For example, the electronic device 101 may include a wired interface (e.g., AUX terminal, HDMI, and/or DP) for transmitting information and/or a signal indicating audio to an external speaker. An embodiment is not limited thereto, and the electronic device 101 may include a wireless interface (e.g., communication circuitry based on Bluetooth, BLE, WiDi, and/or WiFi-direct) for wirelessly transmitting information and/or a signal to an external display and/or an external speaker. An embodiment is not limited thereto, and in an embodiment in which the electronic device 101 is a TV, the electronic device 101 may include the wired interface and/or the wireless interface.

Although the processor 210, the memory 220, the display 230, the speaker 240, the first communication circuitry 251, and the second communication circuitry 252 are illustrated as hardware components included in the electronic device 101, hardware components included in the electronic device 101 are not limited to the hardware component(s) illustrated in FIG. 2. For example, the electronic device 101 may (further) include power circuitry configured to obtain power from a power system (e.g., an infrastructure for providing power, including a power plant).

Referring to FIG. 2, a program (e.g., an accessibility application 222) installed in the memory 220 of the electronic device 101 is illustrated. In an embodiment, a non-transitory computer readable storage medium may be provided, in which a resource (e.g., one or more files including instructions, and other file(s) necessary for executing the instructions) for executing the accessibility application 222 is stored. An operation of the present disclosure may be performed by the electronic device 101 (or the electronic device 101 and/or the processor 210 that executed instructions included in the accessibility application 222 from the non-transitory computer-readable storage medium) in which the accessibility application 222 is installed.

In an embodiment, by executing the accessibility application 222, the processor 210 may detect, identify, or monitor a connection with an external electronic device (e.g., the user terminal 130, the HMD device 262, the laptop PC 264, and/or the server 270) based on the first communication circuitry 251. The accessibility application 222 may be executed based on a background mode, which is a mode that does not provide a screen and/or a user interface (UI) to be displayed through the display 230. A foreground mode, which is a mode different from the background mode, may include a mode of executing a software application to display a screen and/or a UI through the display 230. Based on identifying the external electronic device using the first communication circuitry 251, the processor 210 may obtain, from the external electronic device, information indicating at least one first accessibility function being executed by the external electronic device. In other words, at least one first accessibility function may be executed by the external electronic device prior to establishment of a communication link between the electronic device 101 and the external electronic device through the first communication circuitry 251. The information may include first text indicating the at least one first accessibility function.

For example, the processor 210 may identify, using second texts respectively corresponding to second accessibility functions executable by the electronic device 101 including the processor 210, at least one second accessibility function corresponding to the at least one first accessibility function among the second accessibility functions. For example, the processor 210 may identify the at least one second accessibility function by comparing the first text, included in the information obtained from the external electronic device, with the second texts. For example, the processor 210 may calculate similarities of each of the second texts to the first text. The processor 210 may identify or determine the at least one second accessibility function using the calculated similarities.

For example, the processor 210 may apply the identified at least one second accessibility function to media content being outputted through output circuitry (e.g., the display 230 and/or the speaker 240). For example, the processor 210 may execute at least one second accessibility function to change the media content to be displayed through the display 230. In the above example, based on the execution of the at least one second accessibility function, the processor 210 may at least partially change the media content to be transmitted to the display 230 based on the at least one second accessibility function.

For example, the processor 210 may execute the at least one second accessibility function using an attribute of the at least one first accessibility function being executed in the external electronic device. For example, in order to continuously provide a user experience associated with the at least one first accessibility function being executed in the external electronic device through the electronic device 101, the processor 210 may execute the at least one second accessibility function using an attribute of the at least one first accessibility function.

Similar to the accessibility application 222 being installed in the memory 220 of the electronic device 101, a software application and/or a program similar to the accessibility application may also be installed in an external electronic device including the user terminal 130. An accessibility function executed in the external electronic device based on the software application installed in the external electronic device may have a different name from an accessibility function executable by the electronic device 101, according to a form factor, shape, and/or design of the external electronic device. For example, even if the external electronic device and the electronic device 101 each support substantially similar accessibility functions, names of the accessibility functions may be different from each other. According to an embodiment, the electronic device 101 may be configured to execute an accessibility function of the electronic device 101 that has a different name from an accessibility function being executed in the external electronic device but has substantially the same effect and/or operation as the accessibility function.

Hereinafter, with reference to FIG. 3, an operation of the electronic device 101 and/or the processor 210 of FIG. 2 based on the execution of the accessibility application 222 is described.

FIG. 3 illustrates an exemplary flowchart for describing an operation of an electronic device 101 according to an embodiment. The electronic device 101 of FIG. 3 may include the electronic device 101 of FIG. 1 and/or FIG. 2. An external electronic device 300 of FIG. 3 may include the user terminal 130 of FIG. 1 and/or FIG. 2, the HMD device 262 of FIG. 2, and/or the laptop PC 264 of FIG. 2. Operations of the electronic device 101 of FIG. 3 may be performed by the electronic device 101 of FIG. 1 and/or FIG. 2, and/or the processor 210 of FIG. 2. An order of the operations of FIG. 3 is not limited to an order illustrated in FIG. 3. For example, the electronic device 101 and/or the processor 210 of FIG. 2 may perform the operations of FIG. 3 in an order different from the order illustrated in FIG. 3. For example, the electronic device 101 and/or the processor 210 of FIG. 2 may perform at least two of the operations of FIG. 3 substantially simultaneously (e.g., multi-tasking and/or multi-threading).

Referring to FIG. 3, in operation 305, according to an embodiment, a processor of the electronic device 101 may monitor an external electronic device. For example, using the first communication circuitry 251 of FIG. 2, the processor may continuously (or periodically or repeatedly) identify the external electronic device 300 adjacent to the electronic device 101.

Referring to FIG. 3, in operation 310, according to an embodiment, a processor of the external electronic device 300 may transmit a wireless signal 312. The processor of the external electronic device 300 may transmit the wireless signal 312 (e.g., a beacon signal) for identifying the external electronic device 300 through communication circuitry of the external electronic device 300. The wireless signal 312 may include information (e.g., an identifier of the external electronic device 300, an Internet protocol (IP) address, a media access control (MAC) address, and/or a port number used to establish a communication link) required to establish the communication link with the external electronic device 300. The wireless signal 312 may be transmitted based on a protocol defined for wireless communication over a relatively short distance, such as BLE, UWB, and/or NFC. For example, the wireless signal 312 may include an advertising signal (or an advertising packet) of BLE. The wireless signal 312 of the operation 310 may be an appropriate signal for discovery of the external electronic device 300.

In an embodiment, the wireless signal 312 of the operation 310 may include information (e.g., an ID) indicating a user (or account information associated with the user) logged into the external electronic device 300. For example, when the wireless signal 312 of the operation 310 is received by another electronic device (e.g., the electronic device 101) in which the user logged into the external electronic device 300 is also logged in, the wireless signal 312 may include information that allows the other electronic device to establish a communication link between the external electronic device 300 and the other electronic device more quickly.

In an embodiment, at least one accessibility function may be executed in the external electronic device 300 transmitting the wireless signal 312 of the operation 310. The wireless signal 312 of the operation 310 may cause another electronic device (e.g., the electronic device 101) receiving the wireless signal 312 to execute the at least one accessibility function.

Referring to FIG. 3, information included in the wireless signal 312 transmitted from the external electronic device 300 based on the operation 310 may have a format defined in hyper-text transfer protocol (HTTP). An embodiment is not limited thereto, and the information included in the wireless signal 312 may have a format defined in JavaScript object notation (JSON). An embodiment is not limited thereto, and the information included in the wireless signal 312 may have a format based on extended marked-up language (XML). The wireless signal 312 may include a command and/or an instruction based on an application programming interface (API) that indicates execution of an accessibility function in another electronic device (e.g., the electronic device 101) that has received the wireless signal 312.

Intensity of the wireless signal 312 transmitted from the external electronic device 300 may be inversely proportional to a travel distance (or propagation distance) of the wireless signal 312. For example, when a distance between the electronic device 101 and the external electronic device 300 is (relatively) far, the intensity of the wireless signal 312 propagating to the electronic device 101 may be less than a minimum intensity required to be identified by the electronic device 101. As the distance between the electronic device 101 and the external electronic device 300 decreases, the intensity of the wireless signal 312 propagating to the electronic device 101 may gradually increase. When the distance between the electronic device 101 and the external electronic device 300 is decreased such that the intensity of the wireless signal 312 propagating to the electronic device 101 is greater than or equal to the minimum intensity, the wireless signal 312 may be identified by the processor of the electronic device 101.

Referring to FIG. 3, in operation 315, according to an embodiment, the processor of the electronic device 101 may detect the external electronic device 300. For example, the processor of the electronic device 101 may detect or identify the external electronic device 300 based on receiving the wireless signal 312. The electronic device 101 that has identified the external electronic device 300 based on the wireless signal 312 may obtain or extract information from the wireless signal 312 to establish a communication link with the external electronic device 300. For example, based on the detection of the external electronic device 300 in the operation 315, the processor of the electronic device 101 may establish (wirelessly) a communication link between the external electronic device 300 and the electronic device 101. After the communication link is established, the processor of the electronic device 101 may perform an operation to obtain information on an accessibility function executed (or activated) in the external electronic device 300 from the external electronic device 300.

Referring to FIG. 3, in operation 320, according to an embodiment, the processor of the electronic device 101 may request information associated with an accessibility function. For example, the processor of the electronic device 101 may request the information of the operation 320 from the external electronic device 300 identified using the wireless signal 312. Referring to FIG. 3, a wireless signal 322 for requesting the information may be transmitted from the electronic device 101 to the external electronic device 300. The wireless signal 322 may include an API-based command and/or instruction indicating transmission of the information of the operation 320 in the external electronic device 300. The information (e.g., the command and/or the instruction) included in the wireless signal 322 may have a format of HTTP, XML, and/or JSON. The external electronic device 300 that has received the wireless signal 322 may perform operation 325.

Referring to FIG. 3, in operation 325, according to an embodiment, the processor of the external electronic device 300 may transmit information on accessibility functions executable in the external electronic device 300. For example, the external electronic device 300 that has performed the operation 325 may transmit a wireless signal 327 including the information of the operation 325 to the electronic device 101. The wireless signal 327 may include the information of the operation 325 based on a format of HTTP, XML, and/or JSON. The wireless signal 327 may cause another electronic device (e.g., the external electronic device 300) receiving the wireless signal 327 to switch to a mode that causes execution of an accessibility function (or a function similar to the accessibility function) being executed in the external electronic device 300. For example, the wireless signal 327 may include text based on a JSON format.

The information transmitted from the external electronic device 300 to the electronic device 101 based on the operation 325 may include one or more names and/or one or more descriptions respectively corresponding to one or more accessibility functions executable (or supported by the external electronic device 300) in the external electronic device 300. The one or more descriptions included in the information of the operation 325 may include natural language sentence(s) based on text. The information of the operation 325 may include a list of the one or more accessibility functions executable in the external electronic device 300. The information of the operation 325 may indicate at least one accessibility function (currently) being executed in the external electronic device 300 among the accessibility functions executable in the external electronic device 300. The information of the operation 325 may include attribute(s) of the accessibility functions executable in the external electronic device 300. The attribute may include a level (or an intensity) of a corresponding accessibility function, and/or at least one parameter for personalizing execution of the accessibility function. The electronic device 101 that has received the wireless signal 327 based on the operation 325 may perform operation 330. The format of the information of the operation 325 is exemplarily described with reference to FIG. 5.

Referring to FIG. 3, in operation 330, according to an embodiment, the processor of the electronic device 101 may identify at least one accessibility function executable in the electronic device 101 using the information of the operation 325. For example, the processor may obtain or identify the information generated by the external electronic device 300 based on the operation 325 from the wireless signal 327. Using the information, the processor of the electronic device 101 may identify at least one accessibility function corresponding to at least one accessibility function being executed (or activated) in the external electronic device 300 and executable by the electronic device 101.

For example, the electronic device 101 may classify, using the information of the operation 330 received from the external electronic device 300, the accessibility functions of the external electronic device 300 into an accessibility function executable by the electronic device 101 and an accessibility function not executable by the electronic device 101. Based at least on the classification, the electronic device 101 may generate or obtain table information (e.g., table information referred to as a mapping table) between the accessibility function(s) executable by the electronic device 101 and the accessibility function(s) executable by the external electronic device 300.

For example, when receiving the wireless signal 327 including text {“type”: “relumino”} from the external electronic device 300, the electronic device 101 may parse the text of the wireless signal 327 based on the JSON format. Based on the parsing, the electronic device 101 may identify, from the text, a type and/or name of the accessibility function being executed in the external electronic device 300. For example, the text may indicate that “relumino” is stored in a variable (e.g., a variable indicating the type and/or name of the accessibility function) having a name “type” based on the JSON format. In the example, the electronic device 101 may identify from the text that an accessibility function having a name “relumino” is being executed by the external electronic device 300. The electronic device 101 may search for an accessibility function having a name identical to or similar to “relumino” in a list of accessibility function(s) executable by the electronic device 101.

Referring to FIG. 3, in operation 335, according to an embodiment, the processor of the electronic device 101 may determine an attribute of at least one accessibility function identified based on the operation 330. An attribute of the operation 335 may include numerical value(s) and/or text(s) required for execution of the at least one accessibility function identified based on the operation 330. Based on the operation 335, the processor of the electronic device 101 may display a user interface (UI) object indicating the attribute of the operation 335 to be used for executing the at least one accessibility function identified based on the operation 330, through a display (e.g., the display 230 of FIG. 2).

Referring to FIG. 3, a UI object 337 for determining the attribute of the operation 335 to be displayed through at least a portion of the display of electronic device 101 is illustrated. The UI object 337 may have a shape of a slider bar. Referring to FIG. 3, an example of the UI object 337 displayed by an electronic device is illustrated, in a state in which an accessibility function for a user with low vision is identified based on the operation 330. The UI object 337 may include a slider bar for selecting any one option among three options (e.g., low, moderate, and severe) selectable as an attribute of the accessibility function. For example, the attribute of the accessibility function may include an intensity and/or a level of the accessibility function based on the three designated levels.

Referring to FIG. 3, the electronic device may display, in the UI object 337, an indicator 338-1 positioned on a straight line and positioned at a position corresponding to any one of the three options (e.g., low), and markers 338-2 and 338-3 corresponding to each of the remaining options (e.g., moderate or severe). For example, an option corresponding to the indicator 338-1 may correspond to a first level, which is the lowest level, among the levels of the accessibility function executed to enhance recognition possibility by a user with low vision. For example, an option corresponding to the marker 338-2 may correspond to a second level, which is higher than the first level, among the levels of the accessibility function executed to enhance the recognition possibility by a user with low vision. For example, an option corresponding to the marker 338-3 may correspond to a third level, which is higher than both the first level and the second level, among the levels of the accessibility function executed to enhance the recognition possibility by a user with low vision.

Although the UI object 337 having a shape based on a slider bar is illustrated, an embodiment is not limited thereto, and for example, a dropdown box, a text box, radio button(s), and/or checkbox(es) may be included in the UI object 337 to receive a user input for determining and/or changing the attribute of the accessibility function.

While displaying the UI object 337 through the display, the electronic device 101 may receive a user input associated with the UI object 337. For example, the user input may include a user input for moving the indicator 338-1 in the UI object 337, as a user input based on a button press on a remote controller (e.g., the remote controller 120 of FIG. 1). For example, the user input may include a user input for moving the indicator 338-1 on the UI object 337, as a user input based on a press of at least one button visible in the electronic device 101. For example, while displaying the UI object 337 of FIG. 3, the electronic device 101 having identified a user input pressing a specific button (e.g., a button with a right arrow→printed on it) of the remote controller may move the indicator 338-1 to a position in which the marker 338-2 is displayed. The electronic device 101 may indicate that the level of the accessibility function is determined to be the second level corresponding to the marker 338-2 based on the indicator 338-1 being moved to the position in which the marker 338-2 is displayed.

For example, the user input associated with the UI object 337 may include a natural language sentence for moving the indicator 338-1, as a user input identified from an audio signal received through a microphone. For example, based on identifying a user input including a word representing any one option among the options displayed through the UI object 337, the electronic device 101 may move the position of the indicator 338-1 in the UI object 337 to a position adjacent to the option corresponding to the word. For example, while displaying the UI object 337 of FIG. 3, the electronic device 101 that has identified a user input including a word “severe” may move the indicator 338-1 to a position in which the marker 338-3 associated with the option corresponding to the word is displayed. By displaying the indicator 338-1 at the position in which the marker 338-3 is displayed, the electronic device 101 may indicate that the level of the accessibility function is determined to be the third level corresponding to the marker 338-3.

Although the operation of determining attribute(s) of accessibility function(s) using a user input based on the UI object 337 is described, an embodiment is not limited thereto. For example, the electronic device 101 may identify information required to determine an attribute of an accessibility function from the external electronic device 300 by communicating with the external electronic device 300. For example, when the electronic device 101 identifies an accessibility function for increasing brightness of the display, the electronic device 101 may request information associated with the attribute of the accessibility function from the external electronic device 300. Based on the request, the external electronic device 300 may obtain the information using a sensor (e.g., an illuminance sensor) included in the external electronic device 300. The external electronic device 300 may transmit the obtained information to the electronic device 101. The electronic device 101 may determine the attribute of the accessibility function (e.g., the brightness of the display of the electronic device 101) using the information transmitted from the external electronic device 300.

Referring to FIG. 3, in operation 340, according to an embodiment, the processor of the electronic device 101 may display a preview based on the at least one accessibility function identified based on the operation 330. The operation 340 may be performed based on identifying the accessibility function of the operation 330. The operation 340 may be performed based on determining the attribute of the accessibility function of the operation 335.

Referring to FIG. 3, the electronic device 101 may display the preview of the operation 340 through at least a portion of a display region of the display 230. For example, the electronic device 101 may display a first preview with respect to media content to be displayed without the at least one accessibility function identified based on the operation 330, through a first portion 341 of the display region. For example, the electronic device 101 may display a second preview with respect to media content to be changed by the at least one accessibility function identified based on the operation 330, through a second portion 342 of the display region. When the media content includes a video, both the first preview and the second preview may correspond to any one of image frames (or frame images and/or frames) included in the video. When the media content includes a video, the electronic device 101 may output, display, or reproduce (substantially simultaneously) original media content through the first portion 341 and the media content at least partially changed based on execution of the at least one accessibility function of the operation 330 through the second portion 342.

Referring to FIG. 3, an embodiment of the electronic device 101 displaying the first preview and the second preview through the first portion 341 and the second portion 342, respectively, of the display region, which are divided based on a tab view (or picture-by-picture (PBP)), is illustrated, but an embodiment is not limited thereto. For example, since the first portion 341 and the second portion 342 occupy different portions of the display region of the display 230, the first preview and the second preview may be displayed without overlapping. An embodiment is not limited thereto, and the electronic device 101 may display the first preview and the second preview based on another layout such as picture-in-picture (PIP).

While providing the preview of the operation 340, the electronic device 101 may display on the display 230, a UI object 343 for execution of the at least one accessibility function (e.g., the at least one accessibility function identified based on the operation 330) that was executed for generating the preview. The UI object 343 may be referred to as a button, a visual object, and/or a visual element. A user input associated with the UI object 343 may be identified or detected based on a signal transmitted from a remote controller (e.g., the remote controller 120 of FIG. 1 and/or FIG. 2) indicating pressing of a specific button (e.g., an “OK” button) of the remote controller, and/or a speech (e.g., natural language sentence(s) such as “Okay, let's execute.”) associated with the UI object 343 identified (e.g., based on speech-to-text (STT)) from an audio signal.

Referring to FIG. 3, along with the preview of the operation 340, the electronic device 101 may (further) display on the display 230, a UI object 344 that causes display of the UI object 337 for changing the attribute of the at least one accessibility function of the operation 340. For example, based on receiving a user input associated with the UI object 344, the electronic device 101 may perform the operation 335 again. For example, in response to the user input associated with the UI object 344, the electronic device 101 may display the UI object 337 on the display 230.

The electronic device 101 may perform operation 345 based on a user input received while displaying the preview of the operation 340. Referring to FIG. 3, the processor of the electronic device 101 may perform the operation 345 based on a user input (e.g., the user input with respect to the UI object 343) received while displaying the first preview through the first portion 341 and displaying (simultaneously) the second preview through the second portion 342.

Referring to FIG. 3, in the operation 345, according to an embodiment, the processor of the electronic device 101 may execute the at least one accessibility function identified based on the operation 330. The processor of the electronic device 101 may execute the at least one accessibility function using at least one attribute determined based on the operation 335. Based on the execution of the at least one accessibility function, a video and/or audio of the media content outputted from the electronic device 101 may be at least partially changed.

According to an embodiment, the electronic device 101 may transmit a signal indicating an attribute of at least one accessibility function executed based on the operation 345 to a server (e.g., the server 270 of FIG. 2) different from the external electronic device 300 through communication circuitry. The signal transmitted to the server may include information on the at least one attribute determined based on the operation 335. After being transmitted to the server, the at least one attribute determined based on the operation 335 may be used by any electronic device (e.g., the electronic device 101 and/or another TV different from the electronic device 101) included in the same category (e.g., a category for classifying TVs) as the electronic device 101 to execute at least one accessibility function (e.g., the at least one accessibility function of the operation 330) according to the at least one attribute. For example, the signal indicating the attribute of the at least one accessibility function may be transmitted from the electronic device 101 to the server to associate the attribute with account information commonly logged into the electronic device 101 and the external electronic device 300. The server may store the attribute of the at least one accessibility function based on the signal. After the attribute is stored in the server, when the communication link between the electronic device 101 and the external electronic device 300 is re-established, the electronic device 101 may re-execute the at least one accessibility function using the attribute stored in the server.

After executing the at least one accessibility function according to the operation 345, the electronic device 101 may determine whether to cease the at least one accessibility function being executed by the electronic device 101 based on the distance between the electronic device 101 and the external electronic device 300. For example, when a distance exceeding a threshold distance is identified, the electronic device 101 may cease (at least temporarily) executing the at least one accessibility function. For example, when a distance exceeding the threshold distance is identified, the electronic device 101 may unlink, disassociate, or disconnect the communication link established between the electronic device 101 and the external electronic device 300. When ceasing the execution of the at least one accessibility function, the electronic device 101 may output or reproduce the media content being outputted from the electronic device 101 without any change based on the at least one accessibility function. After the connection with the external electronic device 300 is unlinked, in case that the communication link between the external electronic device 300 and the electronic device 101 is re-established, the electronic device 101 may re-execute the at least one accessibility function using the attribute determined based on the operation 335.

As described above, according to an embodiment, the electronic device 101 may [0084] perform an operation to continuously execute in the electronic device 101, an accessibility function being executed in the external electronic device 300. For example, when a first accessibility function (e.g., a Relumino function, a brightness adjustment function, and/or a color adjustment function) for assisting a user with low vision is being executed in the external electronic device 300, the electronic device 101 may execute, based on detecting the external electronic device 300 based on the operation 315, an accessibility function of the electronic device 101 corresponding to the first accessibility function, by performing the operations 330, 335, 340, and 345. For example, when a second accessibility function, referred to as TalkBack, is being executed in the external electronic device 300, the electronic device 101 may execute an accessibility function of the electronic device 101 corresponding to the second accessibility function based on identifying the external electronic device 300 associated with account information logged into the electronic device 101. The accessibility function of the electronic device 101 corresponding to the second accessibility function may have a different name from TalkBack.

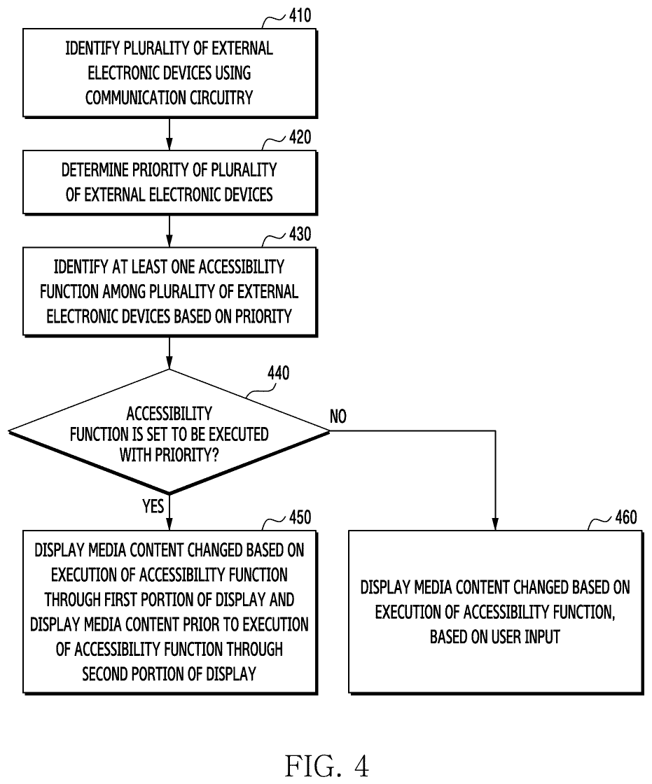

Although the operation of the electronic device 101 detecting one external electronic device 300 is described, an embodiment is not limited thereto. Hereinafter, with reference to FIG. 4, an exemplary operation of the electronic device 101 identifying a plurality of external electronic devices, including the external electronic device 300, is described.

FIG. 4 illustrates an exemplary flowchart for describing an operation of an electronic device that has identified a plurality of external electronic devices. The electronic device 101 of FIGS. 1, 2, and/or 3 may include the electronic device of FIG. 4. A plurality of external electronic devices of FIG. 4 may include the user terminal 130 of FIG. 1 and/or FIG. 2, the HMD device 262 of FIG. 2, the laptop PC 264 of FIG. 2, and/or the external electronic device 300 of FIG. 3. Operations of the electronic device of FIG. 4 may be performed by the electronic device 101 of FIG. 1 and/or FIG. 2, and/or the processor 210 of FIG. 2. An order of the operations of FIG. 4 is not limited to an order illustrated in FIG. 4. For example, the electronic device 101 and/or the processor 210 of FIG. 2 may perform the operations of FIG. 4 in an order different from the order illustrated in FIG. 4. For example, the electronic device 101 and/or the processor 210 of FIG. 2 may perform at least two of the operations of FIG. 4 substantially simultaneously.

Referring to FIG. 4, in operation 410, according to an embodiment, a processor of the electronic device may identify a plurality of external electronic devices using communication circuitry (e.g., the first communication circuitry 251 of FIG. 2). In an embodiment in which the electronic device is a TV, a plurality of users may move toward the electronic device. In this case, distances between the electronic device and a plurality of external electronic devices owned by each of the plurality of users may decrease. Based on the operations 305 and 315 of FIG. 3, the electronic device may identify the plurality of external electronic devices.

The electronic device may perform authentication for each external electronic device based on identifying each of the plurality of external electronic devices. For example, the electronic device may establish a communication link between the electronic device and an external electronic device based on performing authentication based on an ID and/or a password. When each of the plurality of external electronic devices approaches the electronic device, a plurality of communication links may be established between the electronic device and the plurality of external electronic devices. The plurality of communication links may be established for management and/or sharing of accessibility function(s) being executed in each of the plurality of external electronic devices and/or attribute(s) of the accessibility function(s).

Referring to FIG. 4, in operation 420, according to an embodiment, the processor of the electronic device may determine a priority of the plurality of external electronic devices. The electronic device may perform the operation 420 based on identifying the plurality of external electronic devices based on the operation 410. When the plurality of external electronic devices execute different accessibility functions, the electronic device may execute accessibility function(s) being executed in at least one of the plurality of external electronic devices instead of executing the accessibility functions simultaneously. The priority of the operation 420 may be used to determine at least one external electronic device among the plurality of external electronic devices to communicate, in order to execute an accessibility function of the electronic device. For example, the priority of the operation 420 may be used to prevent or reduce conflict between the accessibility functions.

In an embodiment, the priority of the operation 420 may be associated with an order of time points at which each of the plurality of external electronic devices connects to the electronic device. For example, among the plurality of external electronic devices, an external electronic device most recently identified (or connected) may have a higher priority than another external electronic device. In an embodiment, the priority of the operation 420 may be associated with an order of distances of the plurality of external electronic devices from the electronic device. For example, among the plurality of external electronic devices, an external electronic device spaced the closest distance apart from the electronic device may have a higher priority than another external electronic device. In an embodiment, the priority of the operation 420 may be associated with whether each of the plurality of external electronic devices is set as a master device. For example, among the plurality of external electronic devices, an external electronic device set as a master device may have a higher priority than another external electronic device.

Referring to FIG. 4, in operation 430, according to an embodiment, the processor of the electronic device may identify at least one accessibility function among the plurality of external electronic devices based on the priority of the operation 420. For example, the electronic device may request, from the most recently identified (or connected) external electronic device among the plurality of external electronic devices, information associated with at least one accessibility function being executed by the external electronic device. For example, the electronic device may request, from the external electronic device closest to the electronic device among the plurality of external electronic devices, information associated with at least one accessibility function being executed by the external electronic device. For example, the electronic device may request, from the external electronic device set as a master device among the plurality of external electronic devices, information associated with at least one accessibility function being executed by the external electronic device. The request may be performed based on an HTTP protocol. Based on the request, the electronic device may obtain information associated with at least one accessibility function from at least one of the plurality of external electronic devices. The information may have a JSON format.

Among the plurality of external electronic devices, an external electronic device that has received a request associated with an accessibility function from the electronic device may transmit information on at least one accessibility function being executed in the external electronic device, to the electronic device. The information may include a list of at least one accessibility function, and at least one attribute used to execute the at least one accessibility function. The at least one attribute may be determined using data from a sensor (e.g., an illumination sensor, and/or a microphone) of the external electronic device. For example, an attribute used to execute an accessibility function for a user with low vision may include brightness of a surrounding environment identified using an illumination sensor, and/or a brightness value of a display of the external electronic device based on the brightness. For example, an attribute used to execute the accessibility function for a user with low vision may indicate at least one of screen size, font size, resolution, and/or color. For example, an attribute used to execute an accessibility function associated with hearing may indicate volume of a speaker of the external electronic device. For example, an attribute provided from the external electronic device may include data required for receiving attribute(s) to be used for execution of accessibility function(s) from a server (e.g., the server 270 of FIG. 2) different from the external electronic device. In other words, identifying the at least one accessibility function of the operation 430 may be performed to provide a usage environment similar to or identical to a usage environment of the external electronic device, through the electronic device.

Referring to FIG. 4, in operation 440, according to an embodiment, the processor of the electronic device may determine whether an accessibility function is set to be executed with higher priority. For example, a designated mode, such as an accessibility priority provision mode, may be provided as a user-configurable option. When the designated mode is activated, the electronic device may determine to execute the accessibility function with priority. In case that the accessibility function is set to be executed with priority (440—Yes), the electronic device may perform operation 450. In case that the accessibility function is not set to be executed with priority (440—No), the electronic device may perform operation 460.

Referring to FIG. 4, in operation 450, according to an embodiment, the processor of the electronic device may display media content changed based on execution of an accessibility function through a first portion (e.g., the second portion 342 of FIG. 3) of a display (e.g., the display 230 of FIG. 2) and display media content prior to the execution of the accessibility function through a second portion (e.g., the first portion 341 of FIG. 3) of the display. For example, the electronic device may simultaneously display media content to which the accessibility function identified based on the operation 430 is applied, and an original version of the media content, using different portions of the display. When multiple users are viewing the electronic device, a user of at least one external electronic device of the operation 430 may view the media content changed based on the execution of the accessibility function through the first portion. The remaining users may view the original version of the media content through the second portion.

Referring to FIG. 4, in operation 460, according to an embodiment, the processor of the electronic device may display the media content changed based on the execution of the accessibility function, based on a user input. For example, the electronic device may display a visual object, such as the UI object 343 of FIG. 3, for confirming execution of at least one accessibility function identified based on the operation 430. The electronic device may execute the accessibility function based on the user input for the visual object. While displaying the visual object, the electronic device may display the media content without executing the accessibility function. An embodiment is not limited thereto, and the electronic device may display another visual object for confirming whether to maintain the execution of the accessibility function, while displaying the media content changed based on the execution of the accessibility function.

After executing the accessibility function based on at least one of the operations 450 and 460, the electronic device may determine whether to maintain the execution of the accessibility function using the distances between the electronic device and the plurality of external electronic devices. For example, the electronic device may (at least temporarily) cease executing the accessibility function using a distance between the electronic device and at least one external electronic device determined among the plurality of external electronic devices based on the priority of the operation 420. For example, in case that the distance between the at least one external electronic device and the electronic device increases to exceed a threshold distance, the electronic device may cease at least one accessibility function that was being executed to change media content. For example, after ceasing the execution of the accessibility function, the electronic device may perform the operations of FIG. 4 for the remaining external electronic devices. For example, after ceasing the execution of the accessibility function, the electronic device may identify or detect an approach of an additional external electronic device to the electronic device based on the operation 410 and/or the operation 305 of FIG. 3.

FIG. 5 illustrates an exemplary operation of an electronic device that determines an accessibility function to be executed in the electronic device based on a comparison of text. The electronic device 101 of FIGS. 1, 2, and/or 3 may include an electronic device of FIG. 5. For example, the electronic device 101 and/or the processor 210 of FIG. 2 may perform an operation of the electronic device described with reference to FIG. 5. The operation of the electronic device described with reference to FIG. 5 may be associated with at least one of the operations of FIGS. 3 and/or 4.

Referring to FIG. 5, in a state of detecting a user terminal (e.g., the user terminal 130 of FIG. 1 and/or FIG. 2, the HMD device 262 of FIG. 2, the laptop PC 264 of FIG. 2, and/or the external electronic device 300 of FIG. 3), the electronic device may request information 510 on accessibility function(s) executable in the user terminal, from the user terminal. Referring to FIG. 5, the information 510 transmitted from the user terminal based on the request is illustrated. For example, the electronic device may identify the information 510 from the wireless signal 327 of FIG. 3. For example, text and/or a bit sequence in JSON and/or XML format indicating the information 510 may be included in a wireless signal (or a packet) transmitted from the user terminal.

Referring to FIG. 5, the information 510 may indicate a table including records 511 and 512 corresponding to each of the accessibility functions executable by the user terminal. For example, referring to the exemplary record 511 in the information 510, the record 511 corresponding to a specific accessibility function may include, as a column and/or a field, at least one of a name of the specific accessibility function, a description (e.g., description information based on a natural language sentence, referred to as a risk information statement (RIS)) of the specific accessibility function, or one or more setting values (e.g., a flag indicating activation or deactivation of the accessibility function, or a parameter indicating a level and/or an intensity of the accessibility function) used for execution of the specific accessibility function. The RIS may include a description (e.g., caution text) of the accessibility function. By using the information 510, the electronic device may detect or identify an accessibility function (e.g., an accessibility function having a name “Relumino Outline”) being executed in the user terminal among the accessibility functions executable in the user terminal.

In an embodiment, information 520 on accessibility function(s) executable by the electronic device may be stored in the electronic device. The information 520 may be stored in the memory 220 of FIG. 2. The information 520 may be managed based on the execution of the accessibility application 222 of FIG. 2. The electronic device may determine or identify a relationship between the accessibility functions executable by the electronic device and the accessibility functions executable by the user terminal by comparing the information 510 transmitted from the user terminal and the information 520. For example, an accessibility function having substantially the same effect and/or purpose may have different names in the electronic device and the user terminal based on user experience and/or a form factor. Referring to the information 510 of FIG. 5, an accessibility function of emphasizing an outline of a visual object displayed on a screen, as an accessibility function for assisting a user with low vision, may be referred to as “Relumino Outline” in the user terminal, and may be referred to as “Relumino Mode” in the electronic device.

According to an embodiment, based on natural language processing, the electronic device may identify or determine a similarity between the accessibility functions executable in the electronic device and the accessibility functions executable in the user terminal by comparing the information 510 and the information 520. For example, the electronic device may identify or determine an accessibility function of the electronic device that is similar to or matches an accessibility function of the user terminal by comparing a name and/or a description of an accessibility function executable by the user terminal, identified from the information 510, to a name and/or a description of an accessibility function executable by the electronic device, stored in the information 520. The electronic device may compare the accessibility functions of the electronic device and the accessibility functions of the user terminal by executing an artificial intelligence model trained to measure semantic text similarity.

In the present disclosure, the artificial intelligence model may include software, hardware, or any combinations thereof indicating a computational model for simulating a cognitive activity of a living organism (e.g., humans), such as reasoning, creation, and/or classification. For example, the software indicating the computational model may include instructions indicating an execution order of a plurality of computations, and/or a combination of a resource including weights and/or coefficients included in each of the plurality of computations. For example, the hardware for executing the computational model may include a CPU, a GPU, and/or an NPU included in the processor 210 of FIG. 2. The artificial intelligence model executed by the electronic device may be referred to as a trained model in terms of being trained to measure semantic text similarity. The artificial intelligence model may have a structure referred to as a feedforward neural network (FNN), a recurrent neural network (RNN), a convolution neural network (CNN), long-short term memory (LSTM), and/or a transformer. An artificial intelligence model executed in an electronic device such as a TV may be referred to as an on-device model in terms of being executed in a device owned by a user. In the accessibility application 222 of FIG. 2, information for executing the artificial intelligence model may be included.

In an embodiment, based on the execution of the artificial intelligence model, the electronic device may compare texts (e.g., a name and/or a description) respectively indicating the accessibility functions of the user terminal, included in the information 510, and texts respectively indicating the accessibility functions of the electronic device, included in the information 520. For example, to identify an accessibility function of the electronic device similar to the accessibility function (e.g., the accessibility function having the name “Relumino Outline”) of the user terminal indicated by the record 511, the electronic device may compare a name (e.g., “Relumino Outline”) and a description (e.g., “A function of improving visibility by emphasizing the outline of an object displayed on a screen”) included in the record 511 with the names and descriptions respectively included in records 521 and 522 of the information 520.

For example, the electronic device may calculate or obtain a similarity between the records 511 and 521 by inputting the name and the description identified from the record 511 and a name (e.g., “Relumino Mode”) and a description (e.g., “A function that emphasizes the outline of an object included in an image”) identified from the record 521, to the artificial intelligence model. For example, the electronic device may calculate the similarity between the records 511 and 522 by inputting a combination (or vector(s) indicating the combination) of the name and the description identified from the record 511 and a name (e.g., “High contrast caption”) and a description (e.g., “A function that improves the visibility of a caption”) identified from the record 522, to the artificial intelligence model. For example, the electronic device may calculate or identify similarities of each of the records 521 and 522 of the information 520 with respect to the record 511 of the information 510 to identify an accessibility function of the electronic device similar to the accessibility function of the user terminal corresponding to the record 511. Among the identified similarities, when an accessibility function having the greatest similarity (or a similarity exceeding a threshold similarity) is identified, the electronic device may determine the identified accessibility function as the accessibility function of the electronic device that is similar to the accessibility function of the user terminal corresponding to the record 511.

Although an operation of the electronic device identifying an accessibility function of the electronic device similar to the accessibility function of the user terminal corresponding to the record 511 based on the artificial intelligence model is described, an embodiment is not limited thereto. For example, an algorithm for calculating a similarity between texts (or words) may be used. For example, the electronic device may identify first tokens respectively corresponding to words included in the name and the description of the record 511. In the present disclosure, a token corresponding to a specific word may include a vector in a vector space corresponding to the specific word. In the vector space, vectors corresponding to words may be defined based on relationships between words based on meaning, such as synonyms and/or antonyms. The electronic device may identify second tokens respectively corresponding to words included in the name and the description of the record 521. The electronic device may calculate a similarity (e.g., Jaccard similarity, Euclidean similarity, Manhattan similarity, and/or cosine similarity) between the first tokens and the second tokens. In the example, the similarity calculated by the electronic device may be used as the similarity between the accessibility function of the user terminal corresponding to the record 511 and the accessibility function of the user terminal corresponding to the record 521.

An algorithm for calculating a similarity between tokens may be summarized as shown in Table 1.

TABLE 1

| Similarity | | |
|---|---|---|
| Name | Formula | Description |
| Jaccard Similarity | $J ( A , B ) = \frac{\vert A ⋂ B \vert}{\vert A ⋃ B \vert} = \frac{\vert token in A ⋂ token in B \vert}{\vert token in A ⋃ token in B \vert}$ | A similarity calculated based on a relationship |
| | | between a union and an |
| | | intersection of the first |
| | | tokens and the second |
| | | tokens, which may have a |
| | | value between 0 and 1. The |
| | | more similar the tokens are, |
| | | the closer the value may |
| | | approach 1. |
| Euclidean | d(x,y) = | A similarity based on a |
| Similarity (or | \sqrt{(x₁ − y₁)² + (x₂ − y₂)² + . . . + (Xₙ − yₙ)²} | vector distance between the |
| L2 Distance) | | first tokens and the second |
| | | tokens, which may be |
| | | normalized to convert to a |
| | | value between 0 and 1. The |
| | | more similar two tokens are, |
| | | the closer the value may |
| | | approach 0. |
| Manhattan Similarity (or L1 | $MaDistance = {\sum }_{i = 1}^{n} \vert {a}_{i} - {b}_{i} \vert$ | The more similar two tokens are, the more the value may decrease. |
| Distance) | | |
| Cosine Similarity | $cos ( θ ) = \frac{\vec{a} \cdot \vec{b}}{‖ \vec{a} ‖ \cdot ‖ \vec{b} ‖}$ | An algorithm based on a cosine angle between tokens, which may have a |
| | | value between −1 and 1. The |
| | | more similar the tokens are, |
| | | the closer the value may |
| | | approach 1. |

Based on the similarities of the records 511 and 512 of the information 510 and the records 521 and 522 of the information 520, the electronic device may identify an accessibility function of the electronic device similar to each of the accessibility functions of the user terminal. Referring to the exemplary information 510 and the information 520 of FIG. 5, the electronic device may determine that an accessibility function of the electronic device corresponding to the record 521 is similar to the accessibility function of the user terminal corresponding to the record 511. Referring to the exemplary information 510 and the information 520 of FIG. 5, the electronic device may determine that the accessibility function of the electronic device corresponding to the record 522 is similar to the accessibility function of the user terminal corresponding to the record 512.

As described above with reference to the operation 335 of FIG. 3, the electronic device may determine attribute(s) (e.g., setting value(s) included in each of the records 521 and 522 in the information 520) of the accessibility function(s) of the electronic device using the information 510 transmitted from the user terminal. For example, when the accessibility function of the electronic device corresponding to the record 521 is determined to be similar to the accessibility function of the user terminal corresponding to the record 511, the electronic device may change an attribute of the accessibility function corresponding to the record 521 according to an attribute of the accessibility function corresponding to the record 511. For example, when the accessibility function of the electronic device corresponding to the record 522 is determined to be similar to the accessibility function of the user terminal corresponding to the record 512, the electronic device may change or set setting value(s) of the accessibility function corresponding to the record 522 based on setting value(s) of the accessibility function corresponding to the record 512.

When changing the information 520 on the accessibility function(s) of the electronic device using the information 510 obtained from the user terminal, a characteristic of the electronic device different from that of the user terminal may be used. For example, the electronic device may convert an attribute of an accessibility function associated with a display, identified from the information 510, based on a characteristic of the display (e.g., the display 230 of FIG. 2) of the electronic device that has a size different from a display size of the user terminal. The converted attribute may be stored in a record (e.g., the records 521 and 522) of the accessibility function associated with the display in the information 520. For example, the electronic device may determine attributes to be used for execution of the accessibility function of the electronic device based on a difference between a characteristic of the display of the user terminal and the characteristic of the display of the electronic device, including size, brightness, and/or color region.

For example, the electronic device may determine attributes to be used for execution of an accessibility function associated with sound based on a characteristic (e.g., maximum power per frequency and/or band) of a speaker included in the electronic device. For example, the electronic device may change an attribute of an accessibility function executed in the user terminal, indicated by the information 510, based on information (e.g., ambient brightness and/or ambient noise level) identified in the electronic device. For example, the electronic device may change the attribute of the accessibility function executed in the user terminal, indicated by the information 510, based on an interface (e.g., a remote controller and/or voice) of the electronic device different from that of the user terminal. The changed attribute may be stored in the information 520 for execution of the accessibility function of the electronic device.

Based on changing the information 520 based on the information 510 obtained from the user terminal, the electronic device may execute at least one accessibility function using the attribute included in the information 520. Based on the execution of the at least one accessibility function, the electronic device may provide a user experience similar to the at least one accessibility function being executed in the user terminal. In an embodiment in which the information 520 is determined based on a difference between the characteristic of the user terminal and the characteristic of the electronic device, the information 520 may be associated with account information commonly logged into the electronic device and the user terminal. The information 520 associated with the account information may be applied to another electronic device different from the electronic device, which is a TV. Hereinafter, with reference to FIG. 6, an embodiment in which the information 520 determined by the electronic device based on the account information is used for executing an accessibility function of the other electronic device is described.

FIG. 6 illustrates an exemplary operation of an electronic device 101 that obtains an attribute associated with an accessibility function using a server 270. The electronic device 101 of FIGS. 1, 2, and/or 3 may include the electronic device 101 of FIG. 6. The user terminal 130 of FIG. 1 and/or FIG. 2 may include a user terminal 130 of FIG. 6. The server 270 of FIG. 2 may include the server 270 of FIG. 6.

Referring to FIG. 6, an exemplary state in which the user terminal 130 and the electronic device 101 are connected is illustrated. The electronic device 101 that has detected the user terminal 130 may obtain information (e.g., the information 510 of FIG. 5) on accessibility function(s) being executed in the user terminal 130 by performing the operation described with reference to FIGS. 1 to 5. The information may be transmitted through a communication link 621 established between the user terminal 130 and the electronic device 101. The information obtained from the user terminal 130 may be used to determine accessibility function(s) of the electronic device 101 corresponding to the accessibility function(s) being executed in the user terminal 130, and attribute(s) of the accessibility function(s) of the electronic device 101. For example, the user terminal 130 may execute an accessibility function using an attribute determined using a sensor (e.g., an illumination sensor, a GPS, and/or a microphone) of the user terminal 130. In the example, the electronic device 101 may determine an attribute to be used to execute the accessibility function of the electronic device 101 using the determined attribute. In the example, when the user terminal 130 determines the attribute of the accessibility function using brightness of ambient light identified using an illuminance sensor, the electronic device 101 may execute the accessibility function of the electronic device 101 using the determined attribute.

For example, in a case in which the user terminal 130 executes an accessibility function based on an attribute adjusted based on a user input, the electronic device 101 may execute the accessibility function using the adjusted attribute received through the communication link 621. In the case, a user who owns both the electronic device 101 and the user terminal 130 may obtain a user experience similar to that of the user terminal 130 from the electronic device 101 without individually controlling the attribute of the accessibility function of the electronic device 101.

Referring to FIG. 6, when the same user is logged into both the electronic device 101 and the user terminal 130 (e.g., when the same account information is registered in the electronic device 101 and the user terminal 130), the electronic device 101 may transmit the attribute(s) of the accessibility function(s), determined based on communication with the user terminal 130, to the server 270. For example, the electronic device 101 may transmit the attribute(s) of the accessibility function(s), determined by the electronic device 101, to the server 270 through a communication link 622 between the server 270 and the electronic device 101. For example, the electronic device 101 may transmit the information 520 of FIG. 5, which is based on a JSON and/or XML format, to the server 270. The server 270 may store the attribute(s) received from the electronic device 101 in association with the account information logged into the electronic device 101 and the user terminal 130.

The attribute(s) for executing the accessibility function(s) transmitted from the electronic device 101 to the server 270 may be used to execute accessibility function(s) in another electronic device 610 different from the electronic device 101. For example, after the server 270 stores the attribute(s) transmitted from the electronic device 101, a communication link 623 between the user terminal 130 and the other electronic device 610 may be established. The communication link 623 may be established based on short-range wireless communication including the wireless signal 312 of FIG. 3, as a distance between the user terminal 130 and the other electronic device 610 decreases.

In an exemplary state of being connected to the user terminal 130 through the communication link 623, the other electronic device 610 may obtain, from the user terminal 130, the information (e.g., the information 510 of FIG. 5) on the accessibility function(s) being executed in the user terminal 130. For example, the other electronic device 610 may execute accessibility function(s) similar to the accessibility function(s) being executed in the user terminal 130 based on the operation described with reference to FIGS. 3 to 5. An embodiment is not limited thereto, and the other electronic device 610 may obtain attribute(s) associated with the account information of the user terminal 130 from the server 270. For example, the other electronic device 610 may identify the account information logged into the user terminal 130 using the communication link 623. The other electronic device 610 may request from the server 270, the attribute(s) that correspond to the identified account information and are to be used to execute the accessibility function(s), through a communication link 624 established between the server 270 and the other electronic device 610. The server 270 may transmit the attribute(s) transmitted from the electronic device 101 to the other electronic device 610 based on the request.

In the exemplary state of FIG. 6, based on the attribute(s) received from the server 270, the other electronic device 610 may execute one or more accessibility functions. For example, without receiving an attribute for executing an accessibility function from the user terminal 130, the other electronic device 610 may obtain an attribute determined by the electronic device 101, which has a form factor (e.g., a TV) similar to that of the other electronic device 610. By executing the accessibility function using the obtained attribute, the other electronic device 610 may provide a user experience similar to that of the electronic device 101 that has executed the accessibility function. Since the other electronic device 610 executes the accessibility function using the attribute determined by the electronic device 101, the accessibility function may be executed more quickly without additional change (e.g., tuning of the attribute used for executing the accessibility function in the user terminal 130) of the attribute.

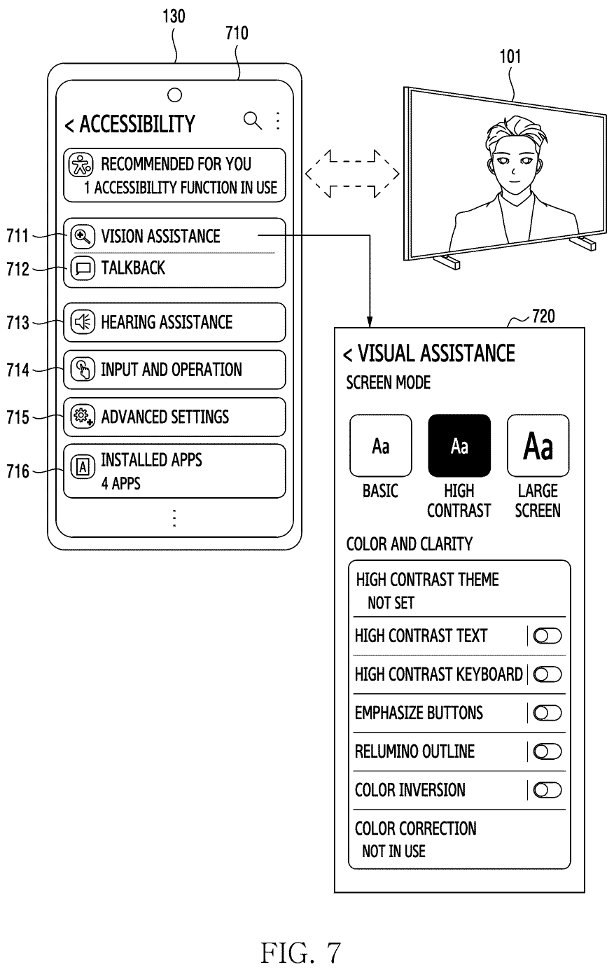

FIG. 7 exemplarily illustrates accessibility functions executable in an electronic device 101 based on communication with an external electronic device (e.g., a user terminal 130). The electronic device 101 of FIGS. 1, 2, and/or 3 may include the electronic device 101 of FIG. 7. The user terminal 130 of FIG. 1 and/or FIG. 2 may include a user terminal 130 of FIG. 7. The electronic device 101 of FIG. 7 may perform the operation for continuous execution of the accessibility functions described with reference to FIGS. 1 to 6.

Referring to FIG. 7, an exemplary state in which the electronic device 101 and the user terminal 130 are connected is illustrated. The user terminal 130 may display a screen 710 for controlling execution of accessibility functions executable through the user terminal 130. Referring to FIG. 7, an exemplary screen 710 displayed through a display of the user terminal 130 is illustrated. The screen 710 may be displayed based on execution of a software application for determining a setting value associated with the user terminal 130, such as a setting application. Referring to the exemplary screen 710 of FIG. 7, the user terminal 130 may provide a list of accessibility functions, which may include items 711, 712, 713, 714, 715, and 716 corresponding to each of the accessibility functions. Each of the items 711, 712, 713, 714, 715, and 716 may be referred to as a UI object, a visual object, and/or a visual element.

Referring to FIG. 7, the item 711 may correspond to accessibility functions for assisting a user with low vision. The user terminal 130 that has identified a user input (e.g., a tap gesture on a portion of the display on which the item 711 is being displayed) to the item 711 may display a screen 720 through the display. Referring to the exemplary screen 720 of FIG. 7, the user terminal 130 may display accessibility functions (e.g., a high contrast theme, high contrast text, a high contrast keyboard, button emphasis, Relumino Outline, color inversion, and/or color correction) executable by the user terminal 130 for assisting a user with low vision, and UI objects for setting attributes of the accessibility functions.

Through the screen 720 of FIG. 7, the user terminal 130 may receive a user input for executing an accessibility function for assisting a user with low vision. Based on receiving the user input, the user terminal 130 may execute the accessibility function based on an attribute determined based on the screen 720. The attribute determined based on the screen 720 may be stored in the user terminal 130, similar to the information 510 of FIG. 5. For example, through the screen 720, the user terminal 130 may obtain or receive an attribute (e.g., thickness, color, and/or brightness of an outline) for executing an accessibility function referred to as “Relumino Outline.”

Referring to FIG. 7, the item 712 may correspond to an accessibility function for assisting a user with hearing loss. For example, the item 712 may correspond to an accessibility function that outputs a natural language description (e.g., a description of a visual object being displayed on a portion of the display touched by the user) corresponding to a user gesture detected by the user terminal 130. Based on a user input for the item 712, the user terminal 130 may execute the accessibility function corresponding to the item 712. Similar to the screen 720 of FIG. 7, based on the user input for the item 712, the user terminal 130 may display another screen for determining an attribute of the accessibility function.

Referring to FIG. 7, the item 713 may correspond to an accessibility function for assisting a user with hearing loss, which is different from the accessibility function corresponding to the item 712. For example, an accessibility function such as a software hearing aid and/or frequency band emphasis (or attenuation) may correspond to the item 713. Based on a user input for the item 713, the user terminal 130 may execute the accessibility function and/or display another screen for determining an attribute of the accessibility function.

Referring to FIG. 7, the item 714 may correspond to an accessibility function for personalizing a user gesture for controlling the user terminal 130. Based on a user input associated with the item 714, the user terminal 130 may execute an accessibility function that matches a specific gesture (e.g., a touch gesture on the display of the user terminal 130) and a specific function of the user terminal 130 (e.g., a function for controlling the user terminal 130, such as volume adjustment).

Referring to FIG. 7, the item 715 may correspond to a function for changing at least one attribute of an accessibility function executed in the user terminal 130. For example, based on a user input associated with the item 715, the user terminal 130 may display another screen for changing the at least one attribute.

Referring to FIG. 7, the item 716 may correspond to a function for displaying a list of at least one software application installed in the user terminal 130 to execute an accessibility function. For example, based on a user input associated with the item 716, the user terminal 130 may display another screen that may include the list of the at least one software application.

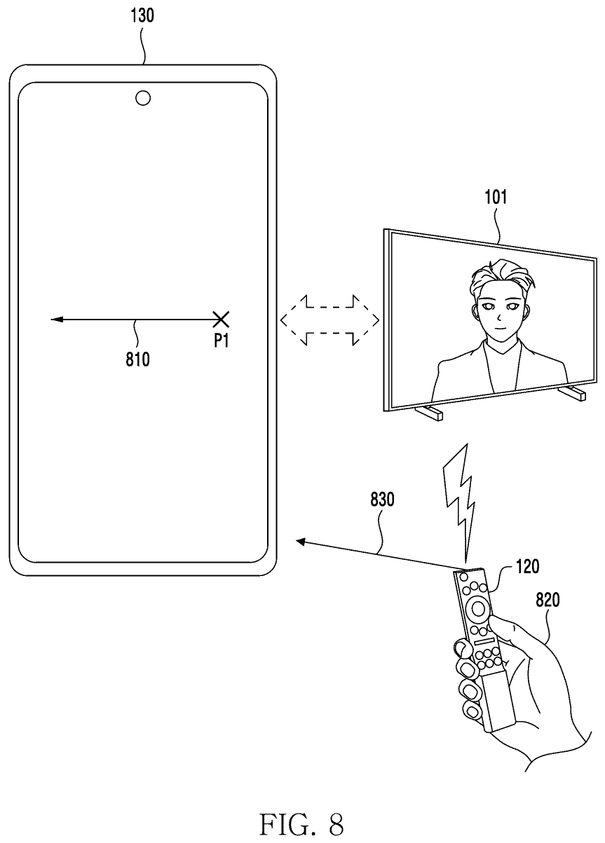

The attributes associated with the accessibility function determined based on the screen 710 of FIG. 7 may be applied to the electronic device 101 connected, directly or indirectly, to the user terminal 130. For example, the electronic device 101 may obtain information (e.g., the information 510 of FIG. 5) including the attribute(s) determined based on the item 711 and/or the screen 720 to execute the accessibility function(s) for assisting a user with low vision. Using the obtained information, the electronic device 101 may execute the accessibility function(s) for assisting a user with low vision. For example, the electronic device 101 may obtain or use the attribute(s) determined based on the items 712 and 713 to execute an accessibility function for assisting a user with hearing loss. For example, the electronic device 101 may request the attribute(s) determined based on the item 714 to perform the accessibility function for personalizing a user gesture. An embodiment of the electronic device 101 executing the accessibility function based on the attribute(s) determined based on the item 714 is described with reference to FIG. 8.

For example, when connected directly or indirectly to the user terminal 130, the electronic device 101 may identify at least one software application installed in the user terminal 130 to execute an accessibility function. For example, the electronic device 101 may identify a software application installed in the user terminal 130 in association with a specific accessibility function, using the list of accessibility functions executable by the user terminal 130. For example, the electronic device 101 may obtain the list of software applications installed in the user terminal 130 from the user terminal 130 to execute the accessibility function.

In an embodiment, based on identifying the software application, the electronic device 101 may obtain or receive one or more files associated with the at least one software application through communication circuitry (e.g., the first communication circuitry 251 of FIG. 2). The one or more files may include a package file for installing the at least one software application. Based on receiving the one or more files, the electronic device 101 may execute at least one accessibility function supported by the at least one software application by executing the at least one software application. To execute the at least one software application, the electronic device 101 may obtain attribute(s) associated with the at least one software application from the user terminal 130. Using the obtained attribute(s), the electronic device 101 may execute the at least one software application.

As described above, the electronic device 101 may continuously execute various accessibility functions supported by the user terminal 130. The electronic device 101 may identify an attribute (or a software application installed in the user terminal 130 to execute an accessibility function) of an accessibility function being executed in the user terminal 130 from the user terminal 130. Based on the identified attribute, the electronic device 101 may provide a user experience similar to a user experience provided through the user terminal 130. For example, the electronic device 101 may apply an accessibility function similar to an accessibility function being executed in the user terminal 130 to media content being outputted through the electronic device 101.

FIG. 8 schematically illustrates an operation of an electronic device 101 that identifies a motion of a user based on an attribute of an accessibility function being executed in an external electronic device (e.g., a user terminal 130). The electronic device 101 of FIGS. 1, 2, and/or 3 may include the electronic device 101 of FIG. 8. The user terminal 130 of FIG. 1 and/or FIG. 2 may include the user terminal 130 of FIG. 8. The electronic device 101 of FIG. 8 may perform the operation for continuous execution of the accessibility functions described with reference to FIGS. 1 to 7.

Referring to FIG. 8, an exemplary state in which the electronic device 101 and the user terminal 130 are connected is illustrated. Referring to FIG. 8, an exemplary state of the user terminal 130 that has executed an accessibility function for personalizing a touch gesture is illustrated. For example, based on the execution of the accessibility function, the user terminal 130 may execute another function indicated by an attribute of the accessibility function based on a swipe gesture in a specific direction (e.g., horizontal direction) on a display. Referring to FIG. 8, the user terminal 130 identifying a swipe gesture that starts at a point p1 on the display and is performed along a horizontal path 810 may execute another function mapped to the swipe gesture based on the accessibility function. The other function may be determined by a user input (e.g., a user input associated with the item 714 of FIG. 7) that adjusts the attribute of the accessibility function or may be personalized. For example, one of a function of changing (e.g., increasing and/or decreasing) volume of the user terminal 130, a function of executing a specific application (e.g., a launcher application and/or a home application) of the user terminal 130, a function for an emergency call, or a function of changing brightness of the display of the user terminal 130 may be determined as the other function.

According to an embodiment, the electronic device 101 may obtain information on an accessibility function being executed in the user terminal 130 based on the operation described with reference to FIGS. 1 to 7, based on identifying the user terminal 130. In the exemplary state of FIG. 8, the electronic device 101 may obtain information (e.g., the information 510 of FIG. 5) from the user terminal 130 indicating that the accessibility function for personalizing a touch gesture (e.g., a swipe gesture) is being executed.

Referring to FIG. 8, in an embodiment in which the electronic device 101 is a TV, the accessibility function for processing a touch gesture of a user may not be executed in the same manner in the electronic device 101 that does not include any hardware (e.g., a touch sensor such as a touch sensitive panel (TSP)) for processing a touch gesture. The electronic device 101 may identify an accessibility function similar to the accessibility function for personalizing a touch gesture being executed in the user terminal 130, among accessibility functions supported by the electronic device 101. For example, the electronic device 101 may identify an accessibility function similar to the accessibility function executed in the user terminal 130 using the list of the accessibility functions supported by the electronic device 101, as described with reference to FIG. 5.

For example, the electronic device 101 may determine an accessibility function (e.g., a motion accessibility function) for personalizing a motion of a remote controller 120 as an accessibility function similar to the accessibility function (e.g., a touch accessibility function) executed in the user terminal 130 for personalizing a touch gesture. The electronic device 101 may determine an attribute of the motion accessibility function using an attribute of the touch accessibility function (e.g., an attribute indicating a horizontal swipe gesture and a function associated with the swipe gesture) obtained from the user terminal 130. Referring to FIG. 8, an exemplary state of the electronic device 101 that has executed the motion accessibility function is illustrated. Based on the attribute of the touch accessibility function executed in the user terminal 130, the electronic device 101 may connect a motion of moving the remote controller 120 in the horizontal direction with a function similar to the function indicated by the attribute of the touch accessibility function, among the functions of the electronic device 101. For example, in case that a horizontal swipe gesture and a function for controlling the volume of the user terminal 130 are associated in the user terminal 130, the electronic device 101 may associate the motion of moving the remote controller 120 in the horizontal direction with the function for controlling the volume of the electronic device 101.

Referring to FIG. 8, the electronic device 101 may execute the motion accessibility function based on a signal indicating the motion of the remote controller 120 received from the remote controller 120. For example, when the remote controller 120 is moved along a direction 830 corresponding to the horizontal direction based on a hand 820 of the user, the remote controller 120 may transmit the signal indicating the motion of the remote controller 120 moved along the direction 830 to the electronic device 101. To measure the motion, the remote controller 120 may include at least one of an inertia measurement unit (IMU), an acceleration sensor, or a gyro sensor. In response to identifying the motion of the remote controller 120 moved along the direction 830 based on the signal transmitted from the remote controller 120, the electronic device 101 may execute a function (e.g., a function for controlling the volume of the electronic device 101) mapped to the motion based on the execution of the motion accessibility function. Each “unit” herein may comprise circuitry.

As described above, even though a first accessibility function supported by the user terminal 130 is not implemented in the electronic device 101, the electronic device 101 may identify or execute a second accessibility function of the electronic device 101 similar to the first accessibility function, based on similarities between the accessibility functions of the electronic device 101 and the first accessibility function of the user terminal 130. The electronic device 101 may determine or set an attribute of the second accessibility function based on an attribute of the first accessibility function of the user terminal 130.

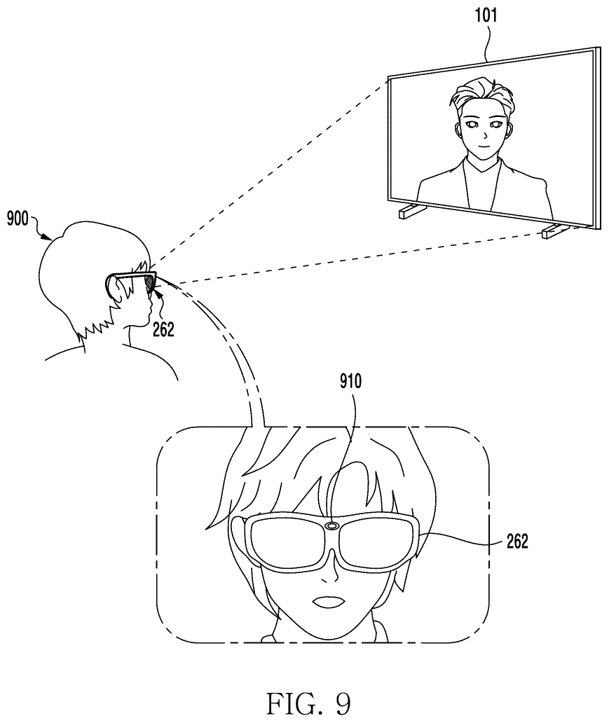

FIG. 9 illustrates an exemplary state of an electronic device 101 connected to an external electronic device, which is a head-wearable electronic device. The electronic device 101 of FIGS. 1, 2, and/or 3 may include the electronic device 101 of FIG. 9. The HMD device 262 of FIG. 2 may include an HMD device 262 of FIG. 9.

Referring to FIG. 9, the HMD device 262 worn on a head of a user 900 is illustrated. The electronic device 101 may obtain information on an accessibility function being executed by the HMD device 262 based on identifying the HMD device 262. The HMD device 262 may include displays facing two eyes of the user 900 when worn by the user 900. The HMD device 262 may include a camera 910 facing a second direction (e.g., a second direction opposite to a first direction) different from a first direction in which the displays are facing. The HMD device 262 may display an image and/or a video obtained through the camera 910, through the displays. For example, the user 900 wearing the HMD device 262 may view the image and/or the video obtained through the camera 910, through the displays. Based on the image and/or the video displayed through the displays, the user 900 may recognize a surrounding environment.

The HMD device 262 may execute an accessibility function for assisting low vision of the user 900. For example, the HMD device 262 may execute an accessibility function for enhancing visibility of a video of the surrounding environment (e.g., an environment in front of the user 900), obtained through the camera 910. For example, the HMD device 262 may execute an accessibility function that visually emphasizes an outline of a visual object (e.g., a visual object corresponding to a subject) represented in the video. The accessibility function that visually emphasizes an outline of a visual object may be referred to as a visibility accessibility function. The HMD device 262 that has executed the visibility accessibility function may synthesize an outline based on an attribute (e.g., thickness and/or color of the outline) set by the visibility accessibility function into the video.

Referring to FIG. 9, the electronic device 101 that has identified the HMD device 262 may establish a communication link between the HMD device 262 and the electronic device 101. Through the communication link, the electronic device 101 may obtain information from the HMD device 262 on an accessibility function (e.g., the visibility accessibility function) being executed by the HMD device 262. Based on the information, the electronic device 101 may execute the visibility accessibility function.

Referring to FIG. 9, when the electronic device 101 and the HMD device 262 are connected, directly or indirectly, the electronic device 101 may execute the visibility accessibility function being executed in the HMD device 262. Referring to FIG. 9, in case that the user 900 wearing the HMD device 262 views the electronic device 101, media content being outputted from the electronic device 101 may be first changed by a visibility accessibility function executed in the electronic device 101 and then changed again by the visibility accessibility function executed in the HMD device 262. To reduce distortion of the media content caused by redundant execution of the visibility accessibility function, the electronic device 101 may at least temporarily cease the visibility accessibility function being executed in the electronic device 101, based on identifying the HMD device 262 facing a display of the electronic device 101. For example, the HMD device 262 may transmit a signal to the electronic device 101 to cease the execution of the visibility accessibility function, based on identifying the electronic device 101 using the image and/or the video obtained through the camera 910. The electronic device 101 that has received the signal may temporarily cease the execution of the visibility accessibility function.

Based on the operations described with reference to FIGS. 1 to 9, the electronic device 101 may execute an accessibility function being executed by an external electronic device including the HMD device 262. When a distance between the electronic device 101 and the HMD device 262 increases, the electronic device 101 may cease executing the accessibility function. Hereinafter, with reference to FIG. 10, an exemplary operation in which the electronic device 101 that executes an accessibility function determines whether to cease executing the accessibility function is described.

FIG. 10 illustrates an exemplary operation of an electronic device 101 that determines whether to terminate an accessibility function executed based on communication with an external electronic device (e.g., a user terminal 130). The electronic device 101 of FIGS. 1, 2, and/or 3 may include the electronic device 101 of FIG. 9. The user terminal 130 of FIG. 1 and/or FIG. 2 may include the user terminal 130 of FIG. 10. The electronic device 101 of FIG. 10 may perform the operation for continuous execution of the accessibility functions described with reference to FIGS. 1 to 9.

Referring to FIG. 10, an exemplary state in which the electronic device 101 and the user terminal 130 are (wirelessly) connected is illustrated. The electronic device 101 may identify a first accessibility function being executed in the user terminal 130 by communicating with the user terminal 130. The electronic device 101 may identify a third accessibility function corresponding to the first accessibility function among second accessibility functions supported by the electronic device 101. The electronic device 101 may execute the third accessibility function based on an attribute for executing the first accessibility function.

Referring to FIG. 10, the electronic device 101 may determine whether to cease the execution of the third accessibility function based on a distance d between the electronic device 101 and the user terminal 130. The distance d may be determined based on a parameter associated with a communication link established between the electronic device 101 and the user terminal 130, such as a Received Signal Strength Indicator (RSSI). The electronic device 101 may cease the execution of the third accessibility function based on identifying the distance d increasing beyond a threshold distance.

The electronic device 101 may display a UI object 1010 for confirming the cessation of the execution of the third accessibility function based on identifying the distance d increasing beyond the threshold distance. Although the UI object 1010 having a shape of a pop-up window displayed on a display of the electronic device 101 is illustrated, an embodiment is not limited thereto. For example, the electronic device 101 may overlappingly display the UI object 1010 on an image and/or a video being displayed through the display. The electronic device 101 may display the UI object 1010, which includes a visual object 1011 for ceasing the execution of the third accessibility function, and a visual object 1012 for maintaining the execution of the third accessibility function. Although the visual objects 1011 and 1012 having a shape of a button are illustrated, an embodiment is not limited thereto. The UI object 1010 may be displayed not only through the electronic device 101 but also through a display of the user terminal 130.

In response to a user input (e.g., a user input based on a remote controller 120 and/or a natural language input for the cessation of the execution of the third accessibility function) associated with the visual object 1011, the electronic device 101 may cease the execution of the third accessibility function. Based on the user input associated with the visual object 1012, the electronic device 101 may maintain the execution of the third accessibility function. Based on a user input for at least one of the visual objects 1011 and 1012, the electronic device 101 may cease displaying the UI object 1010.

An embodiment of ceasing the execution of the third accessibility function executed in the electronic device 101 based on the distance d between the electronic device 101 and the user terminal 130 is illustrated, an embodiment is not limited thereto. For example, the electronic device 101 may cease the execution of the third accessibility function based on a gesture (e.g., a tap gesture) of the user terminal 130 contacting the remote controller 120 and/or the electronic device 101. In the example, the remote controller 120 and/or the electronic device 101 may detect or identify the gesture using circuitry (e.g., circuitry based on NFC, UWB, and/or BLE) for detecting contact of the user terminal 130. Based on the gesture, the electronic device 101 may display the UI object 1010 and/or cease the execution of the third accessibility function.

Although an embodiment of ceasing the execution of the third accessibility function based on a tap gesture is described, an embodiment is not limited thereto. For example, an operation of the electronic device 101 for continuously executing an accessibility function being executed in the user terminal 130 may be performed based on a tap gesture of the user terminal 130 contacting the remote controller 120 and/or the electronic device 101.

As described above, according to an embodiment, the electronic device 101 may be configured to execute an accessibility function corresponding to an accessibility function being executed in an external electronic device (e.g., the user terminal 130) adjacent to the electronic device 101. The electronic device 101 may identify an accessibility function of the electronic device 101 corresponding to the accessibility function being executed in the external electronic device using information on accessibility functions of the external electronic device. For example, when substantially the same accessibility functions has different names in each of the electronic device 101 and the external electronic device, the electronic device 101 may compare the names to identify an accessibility function of the electronic device 101 that is similar to or identical to the accessibility function being executed in the external electronic device.

In an embodiment, in a specific electronic device, such as a television (TV), a method of continuously (or seamlessly) executing an accessibility function being executed in another electronic device (e.g., a user terminal such as a smartphone) may be required. In an embodiment, when accessibility functions executable in different electronic devices have different names, a method of identifying and/or executing an accessibility function of one electronic device corresponding to an accessibility function of another electronic device, using similarities between the names, may be required. As described above, according to an embodiment, an electronic device (e.g., the electronic device 101 of FIG. 1) may comprise a display (e.g., the display 230 of FIG. 2), communication circuitry (e.g., the first communication circuitry 251 of FIG. 2), memory (e.g., the memory 220 of FIG. 2) comprising one or more storage media storing instructions, and at least one processor (e.g., the processor 210 of FIG. 2) comprising processing circuitry. The instructions, when executed by the at least one processor individually or collectively, may cause the electronic device to identify an external electronic device (e.g., the user terminal 130, the HMD device 262, and/or the laptop PC 264 of FIG. 1 and/or FIG. 2) using the communication circuitry. The instructions, when executed by the at least one processor individually or collectively, may cause the electronic device to obtain, based on identifying the external electronic device, from the external electronic device, information (e.g., the information 510 of FIG. 5) indicating at least one first accessibility function being executed by the external electronic device. The instructions, when executed by the at least one processor individually or collectively, may cause the electronic device to identify, using the obtained information, at least one second accessibility function among accessibility functions executable by the electronic device which corresponds to the at least one first accessibility function indicated by the information. The instructions, when executed by the at least one processor individually or collectively, may cause the electronic device to execute the at least one second accessibility function to change media content to be displayed through the display. According to an embodiment, an electronic device (e.g., a TV) may continuously (or seamlessly) execute an accessibility function being executed in an external electronic device including a smartphone. According to an embodiment, an electronic device may identify or execute an accessibility function of the electronic device corresponding to an accessibility function being executed in an external electronic device.

Each embodiment herein may be used in combination with any other embodiment(s) described herein.

For example, the instructions, when executed by the at least one processor individually or collectively, may cause the electronic device to determine, by comparing texts indicating the at least one first accessibility function included in the information to texts of the accessibility functions executable by the electronic device, the at least one second accessibility function.

For example, the instructions, when executed by the at least one processor individually or collectively, may cause the electronic device to execute the at least one second accessibility function using an attribute of the at least one first accessibility function included in the information.

For example, the instructions, when executed by the at least one processor individually or collectively, may cause the electronic device to display a user interface (UI) object indicating an attribute to be used to execute the at least one second accessibility function, via the display. The instructions, when executed by the at least one processor individually or collectively, may cause the electronic device to change, based on receiving a user input associated with the UI object, the attribute indicated by the UI object. The instructions, when executed by the at least one processor individually or collectively, may cause the electronic device to execute the at least one second accessibility function using the changed attribute.

For example, the instructions, when executed by the at least one processor individually or collectively, may cause the electronic device to transmit, to a second external electronic device different from the external electronic device which is a first external electronic device via the communication circuitry, a signal indicating the changed attribute. The changed attribute may be used to execute, after being transmitted to the second external electronic device, the at least one second accessibility function according to the changed attribute by a third external electronic device in a category in which the electronic device is included.

For example, the instructions, when executed by the at least one processor individually or collectively, may cause the electronic device to transmit, to the second external electronic device, the signal to associate the changed attribute with account information commonly logged into the electronic device and the first external electronic device.

For example, the instructions, when executed by the at least one processor individually or collectively, may cause the electronic device to obtain, based on identifying the external electronic device which is a first external electronic device and a second external electronic device using the communication circuitry, a first distance between the first external electronic device and the electronic device, and a second distance between the second external electronic device and the electronic device. The instructions, when executed by the least one processor individually or collectively, may cause the electronic device to obtain, based on obtaining the first distance shorter than the second distance, the information from the first external electronic device.

For example, the instructions, when executed by the at least one processor individually or collectively, may cause the electronic device to obtain, based on identifying the external electronic device which is a first external electronic device and a second external electronic device using the communication circuitry, the information from the first external electronic device which is set as a master device among the first external electronic device and the second external electronic device.

For example, the instructions, when executed by the at least one processor individually or collectively, may cause the electronic device to display, based on identifying the at least one second accessibility function, a first preview with respect to the media content to be displayed without the at least one second accessibility function, via a first portion of a display region of the display. The instructions, when executed by the at least one processor individually or collectively, may cause the electronic device to display a second preview with respect to the media content to be changed by the at least one second accessibility function via a second portion of the display region.

For example, the instructions, when executed by the at least one processor individually or collectively, may cause the electronic device to execute, based on a user input received while concurrently displaying the first preview and the second preview, the at least one second accessibility function.

For example, the instructions, when executed by the at least one processor individually or collectively, may cause the electronic device to identify a software application associated with the at least one first accessibility function using the information. The instructions, when executed by the at least one processor individually or collectively, may cause the electronic device to receive, based on identifying the software application, one or more files associated with the software application via the communication circuitry. The instructions, when executed by the at least one processor individually or collectively, may cause the electronic device to execute, based on receiving the one or more files, the at least one second accessibility function by executing the software application.

As described above, in an embodiment, a method of an electronic device including a display and communication circuitry may be provided. The method may comprise identifying an external electronic device using the communication circuitry. The method may comprise obtaining, based on identifying the external electronic device, from the external electronic device, information indicating at least one first accessibility function being executed by the external electronic device. The method may comprise identifying, using the obtained information, at least one second accessibility function among accessibility functions executable by the electronic device, which corresponds to the at least one first accessibility function indicated by the information. The method may comprise executing the at least one second accessibility function to change media content to be displayed through the display.

For example, the identifying the at least one second accessibility function may comprise determining, by comparing texts indicating the at least one first accessibility function included in the information to texts of the accessibility functions executable by the electronic device, the at least one second accessibility function.

For example, the executing may comprise executing the at least one second accessibility function using an attribute of the at least one first accessibility function included in the information.

For example, the executing the at least one second accessibility function may comprise displaying a user interface (UI) object indicating an attribute to be used to execute the at least one second accessibility function, via the display. The executing the at least one second accessibility function may comprise changing, based on receiving a user input associated with the UI object, the attribute indicated by the UI object. The executing the at least one second accessibility function may comprise executing the at least one second accessibility function using the changed attribute.

For example, the method may comprise transmitting, to a second external electronic device different from the external electronic device which is a first external electronic device via the communication circuitry, a signal indicating the changed attribute. The changed attribute may be used to execute, after being transmitted to the second external electronic device, the at least one second accessibility function according to the changed attribute by a third external electronic device in a category in which the electronic device is included.

For example, the transmitting may comprise transmitting, to the second external electronic device, the signal to associate the changed attribute with account information commonly logged into the electronic device and the first external electronic device.

For example, the obtaining may comprise obtaining, based on identifying the external electronic device which is a first external electronic device and a second external electronic device using the communication circuitry, a first distance between the first external electronic device and the electronic device, and a second distance between the second external electronic device and the electronic device. The obtaining may comprise obtaining, based on obtaining the first distance shorter than the second distance, the information from the first external electronic device.

For example, the obtaining may comprise obtaining, based on identifying the external electronic device which is a first external electronic device and a second external electronic device using the communication circuitry, the information from the first external electronic device which is set as a master device among the first external electronic device and the second external electronic device.

For example, the method may comprise displaying, based on identifying the at least one second accessibility function, a first preview with respect to the media content to be displayed without the at least one second accessibility function, via a first portion of a display region of the display. The method may comprise displaying a second preview with respect to the media content to be changed by the at least one second accessibility function via a second portion of the display region.

For example, the executing may comprise executing, based on a user input received while concurrently displaying the first preview and the second preview, the at least one second accessibility function.

For example, the method may comprise identifying a software application associated with the at least one first accessibility function using the information. The method may comprise receiving one or more files associated with the software application via the communication circuitry, based on identifying the software application. The method may comprise executing the at least one second accessibility function by executing the software application, based on receiving the one or more files.

As described above, in an embodiment, a non-transitory computer readable storage medium including instructions may be provided. The instructions, when executed by an electronic device comprising output circuitry including at least one of a display or a speaker, and communication circuitry, may cause the electronic device to identify an external electronic device using the communication circuitry. The instructions, when executed by the electronic device, may cause the electronic device to obtain, based on identifying the external electronic device, from the external electronic device, first text indicating at least one first accessibility function being executed by the external electronic device. The instructions, when executed by the electronic device, may cause the electronic device to identify, using second texts respectively corresponding to second accessibility functions executable by the electronic device, at least one second accessibility function corresponding to the at least one first accessibility function among the second accessibility functions. The instructions, when executed by the electronic device, may cause the electronic device to apply, to media content being output through the output circuitry, the identified at least one second accessibility function. “Based on” as used herein covers based at least on.

For example, the instructions, when executed by the electronic device, may cause the electronic device to identify the at least one second accessibility function, among the second accessibility functions including at least one of an accessibility function to change color distribution of a video in the media content being reproduced via the display using an attribute associated with a color blindness, an accessibility function to display one or more prompts for describing the media content, or an accessibility function to output an audio signal via the speaker for describing a video in the media content being reproduced via the display.

As described above, according to an embodiment, an electronic device may comprise output circuitry including at least one of a display or a speaker, communication circuitry, memory comprising one or more storage media storing instructions, and at least one processor comprising processing circuitry. The instructions, when executed by the at least one processor individually or collectively, may cause the electronic device to identify an external electronic device using the communication circuitry. The instructions, when executed by the at least one processor individually or collectively, may cause the electronic device to obtain, based on identifying the external electronic device, from the external electronic device, first text indicating at least one first accessibility function being executed by the external electronic device. The instructions, when executed by the at least one processor individually or collectively, may cause the electronic device to identify, using second texts respectively corresponding to second accessibility functions executable by the electronic device, at least one second accessibility function corresponding to the at least one first accessibility function among the second accessibility functions. The instructions, when executed by the at least one processor individually or collectively, may cause the electronic device to apply, to media content being output through the output circuitry, the identified at least one second accessibility function.

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

For example, the instructions, when executed by the at least one processor individually or collectively, may cause the electronic device to identify the at least one second accessibility function, among the second accessibility functions including at least one of an accessibility function to change color distribution of a video in the media content being reproduced via the display using an attribute associated with a color blindness, an accessibility function to display one or more prompts for describing the media content, or an accessibility function to output an audio signal via the speaker for describing a video in the media content being reproduced via the display.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

1. An electronic device comprising:
a display;
communication circuitry;
memory comprising one or more storage media storing instructions; and
at least one processor comprising processing circuitry,
wherein the instructions, when executed by the at least one processor individually and/or collectively, cause the electronic device to:
identify an external electronic device via at least the communication circuitry;
based on identifying the external electronic device, obtain, from the external electronic device, information indicating at least one first accessibility function of the external electronic device;
identify, based on the obtained information, at least one second accessibility function among accessibility functions executable by the electronic device, which corresponds to the at least one first accessibility function indicated by the information; and
execute the at least one second accessibility function at least to change media content to be displayed through the display.

2. The electronic device of claim 1, wherein the instructions, when executed by the at least one processor individually and/or collectively, cause the electronic device to:
determine, at least by comparing texts indicating the at least one first accessibility function included in the information to texts of the accessibility functions executable by the electronic device, the at least one second accessibility function.

3. The electronic device of claim 1, wherein the instructions, when executed by the at least one processor individually and/or collectively, cause the electronic device to:
execute the at least one second accessibility function based on an attribute of the at least one first accessibility function included in the information.

4. The electronic device of claim 1, wherein the instructions, when executed by the at least one processor individually and/or collectively, cause the electronic device to:
display a user interface (UI) object indicating an attribute to be used to execute the at least one second accessibility function, via the display;
based on receiving a user input associated with the UI object, change the attribute indicated by the UI object; and
execute the at least one second accessibility function based on the changed attribute.

5. The electronic device of claim 4, wherein the instructions, when executed by the at least one processor individually and/or collectively, cause the electronic device to:
transmit, to a second external electronic device different from the external electronic device which is a first external electronic device via the communication circuitry, a signal indicating the changed attribute;
wherein the changed attribute is configured to be used to execute, after being transmitted to the second external electronic device, the at least one second accessibility function according to the changed attribute by a third external electronic device in a category in which the electronic device is included.

6. The electronic device of claim 5, wherein the instructions, when executed by the at least one processor individually and/or collectively, cause the electronic device to:
transmit, to the second external electronic device, the signal to associate the changed attribute with account information commonly logged into the electronic device and the first external electronic device, and
wherein the first accessibility function is an accessibility function being executed by the first external electronic device.

7. The electronic device of claim 1, wherein the instructions, when executed by the at least one processor individually and/or collectively, cause the electronic device to:
based on identifying the external electronic device which is a first external electronic device and a second external electronic device via the communication circuitry, obtain a first distance between the first external electronic device and the electronic device, and a second distance between the second external electronic device and the electronic device;
based on identifying the first distance shorter than the second distance, obtain the information from the first external electronic device.

8. The electronic device of claim 1, wherein the instructions, when executed by the at least one processor individually and/or collectively, cause the electronic device to:
based on identifying the external electronic device which is a first external electronic device and a second external electronic device, obtain the information from the first external electronic device which is set as a master device among the first external electronic device and the second external electronic device.

9. The electronic device of claim 1, wherein the instructions, when executed by the at least one processor individually and/or collectively, cause the electronic device to:
based on identifying the at least one second accessibility function:
display a first preview with respect to the media content to be displayed without the at least one second accessibility function, via a first portion of a display region of the display; and
display a second preview with respect to the media content to be changed by the at least one second accessibility function via a second portion of the display region.

10. The electronic device of claim 9, wherein the instructions, when executed by the at least one processor individually and/or collectively, cause the electronic device to:
based on a user input received while concurrently displaying the first preview and the second preview, execute the at least one second accessibility function.

11. The electronic device of claim 1, wherein the instructions, when executed by the at least one processor individually and/or collectively, cause the electronic device to:
identify a software application associated with the at least one first accessibility function using the information;
based on identifying the software application, receive one or more files associated with the software application via the communication circuitry; and
based on receiving the one or more files, execute the at least one second accessibility function by executing the software application.

12. A method of an electronic device including a display and communication circuitry, the method comprising:
identifying an external electronic device using the communication circuitry;
based on identifying the external electronic device, obtaining, from the external electronic device, information indicating at least one first accessibility function executed by the external electronic device;
identifying, using the obtained information, at least one second accessibility function among accessibility functions executable by the electronic device, which corresponds to the at least one first accessibility function indicated by the information; and
executing the at least one second accessibility function to change media content to be displayed through the display.

13. The method of claim 12, wherein the identifying the at least one second accessibility function comprises:
determining, at least by comparing texts indicating the at least one first accessibility function included in the information to texts of the accessibility functions executable by the electronic device, the at least one second accessibility function.

14. The method of claim 12, wherein the executing comprises:
executing the at least one second accessibility function using an attribute of the at least one first accessibility function included in the information.

15. The method of claim 12, wherein the executing the at least one second accessibility function comprises:
displaying a user interface (UI) object indicating an attribute to be used to execute the at least one second accessibility function, via the display;
based on receiving a user input associated with the UI object, changing the attribute indicated by the UI object; and
executing the at least one second accessibility function using the changed attribute.

16. The method of claim 15, further comprises:
transmitting, to a second external electronic device different from the external electronic device which is a first external electronic device, a signal indicating the changed attribute;
wherein the changed attribute is used to execute, after being transmitted to the second external electronic device, the at least one second accessibility function according to the changed attribute by a third external electronic device in a category in which the electronic device is included.

17. The method of claim 16, wherein the transmitting comprises:
transmitting, to the second external electronic device, the signal to associate the changed attribute with account information commonly logged into the electronic device and the first external electronic device.

18. The method of claim 12, wherein the obtaining comprises:
based on identifying the external electronic device which is a first external electronic device and a second external electronic device using the communication circuitry, obtaining a first distance between the first external electronic device and the electronic device, and a second distance between the second external electronic device and the electronic device;
based on obtaining the first distance shorter than the second distance, obtaining the information from the first external electronic device.

19. The method of claim 12, wherein the obtaining comprises:
based on identifying the external electronic device which is a first external electronic device and a second external electronic device, obtaining the information from the first external electronic device which is set as a master device among the first external electronic device and the second external electronic device.

20. The method of claim 12, further comprises:
based on identifying the at least one second accessibility function:
displaying a first preview with respect to the media content to be displayed without the at least one second accessibility function, via a first portion of a display region of the display; and
displaying a second preview with respect to the media content to be changed by the at least one second accessibility function via a second portion of the display region.
